(19) United States
(12) Patent Application Publication
(10) Pub. No.: US 2026/0085381 A1
(43) Pub. Date: Mar. 26, 2026

(54) METHODS FOR EXTRACTING CRITICAL MINERALS FROM SEDIMENTARY ROCK

(71) Applicant: West Virginia University Board of Governors on Behalf of West Virginia University, Morgantown, WV (US)

(72) Inventors: Shailee Bhattacharya, Morgantown, WV (US); Shikha Sharma, Morgantown, WV (US)

(21) Appl. No.: 19/338,830

(22) Filed: Sep. 24, 2025

Related U.S. Application Data
(60) Provisional application No. 63/698,551, filed on Sep. 24, 2024.

(51) Int. Cl. C22B 26/12; C01D 15/04; C01D 15/06; C22B 3/06; C22B 3/16; C22B 3/44

(52) U.S. Cl. CPC C22B 26/12; C01D 15/04; C01D 15/06; C22B 3/065; C22B 3/16; C22B 3/44

(57) ABSTRACT

A method for extracting critical minerals from organic-rich black shale having at least 0.5 wt % total organic carbon is disclosed. The sequential leaching process comprises water washing, followed by treatment with magnesium chloride solution, a first acid (such as acetic acid) to dissolve carbonates, a reducing agent solution containing hydroxylamine hydrochloride to target Fe—Mn oxyhydroxides, and mineral acid treatment (such as nitric acid) to extract from pyrite phases. The method particularly targets lithium extraction, recovering at least 20% of total lithium content from pyrite-associated phases. The method is most effective for shales with high organic carbon content (≥5 wt %) and pyrite content (≥2.5 wt %). Other extractable critical minerals include cobalt, gallium, germanium, hafnium, indium, magnesium, manganese, nickel, niobium, rubidium, tantalum, tellurium, and zinc.

### CROSS-REFERENCE TO RELATED APPLICATIONS

This application claims the benefit of U.S. Provisional Application No. 63/698,551, filed on Sep. 24, 2024, which is incorporated herein by reference in its entirety.

### STATEMENT REGARDING COLOR DRAWINGS

In accordance with 37 C.F.R. § 1.84(a)(2)(ii), this application file contains at least one drawing executed in color. Copies of this patent or patent application publication with color drawing(s) will be provided by the United States Patent and Trademark Office upon request and payment of the necessary fee.

### BACKGROUND

Demand for clean energy technologies, and thus demand for the materials used to produce them, is increasing. These materials include some critical minerals, which can have a risk of supply chain distribution. Critical minerals are defined by various governmental agencies as minerals that are essential to economic or national security and have a supply chain vulnerable to disruption. Examples of critical minerals commonly used in clean energy applications include lithium for battery storage systems, rare earth elements for wind turbine magnets and electric vehicle motors, cobalt for battery cathodes, graphite for battery anodes, and platinum group metals for fuel cells and electrolyzers. The supply chain vulnerabilities for these materials often stem from geographic concentration of production, limited processing capacity, lack of suitable substitutes, and geopolitical factors affecting trade relationships.

Utilizing new or untapped sources of critical minerals is an important aspect in meeting the increasing demand for clean energy technologies that produce, transmit, store, and/or conserve energy. Traditional mining operations have focused primarily on high-grade ore deposits, but as these resources become depleted or more difficult to access, alternative sources must be explored. Geological systems present one potential source of critical minerals, including sedimentary formations that may contain lower concentrations of critical minerals but are more widely distributed and potentially more accessible than conventional ore bodies.

However, there remains a need to better utilize geological systems as sources of critical minerals and provide improved methods for extracting critical minerals from geological systems. Conventional extraction methods may not be economically viable for lower-grade deposits or may cause significant environmental disruption. Additionally, existing extraction techniques may not be optimized for the specific mineralogical characteristics of sedimentary rock formations, which can differ substantially from traditional hard rock mining targets in terms of mineral distribution, host rock properties, and extraction requirements. These needs and other needs are satisfied by the present disclosure.

### SUMMARY

In accordance with the purpose(s) of the disclosure, as embodied and broadly described herein, the disclosure, in one aspect, relates to a method, comprising: providing a shale particulate composition comprising a total organic carbon content of at least 0.5 wt % and at least one critical mineral; mixing the shale particulate composition with water, thereby forming a slurry; filtering the slurry, thereby forming a shale particulate retentate and a first filtrate; mixing the shale particulate retentate and a magnesium chloride solution, thereby forming a magnesium chloride slurry comprising a first solid and a first leachate; mixing the first solid with a first acid, thereby forming an organic acid slurry comprising a second solid and a second leachate; mixing the second solid with a reducing agent solution, thereby forming a reduced slurry comprising a third solid and a third leachate; and mixing the third solid with a mineral acid, thereby forming a mineral acid slurry comprising a stripped solid and a final leachate; wherein the final leachate comprises at least one extracted critical mineral.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

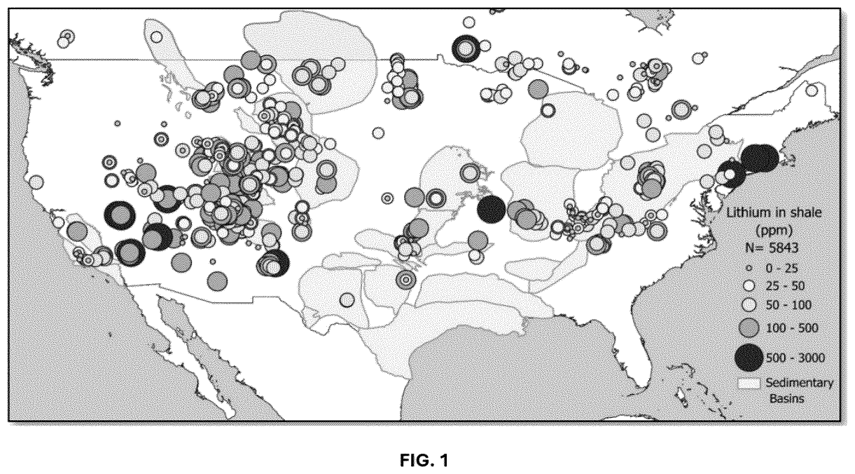

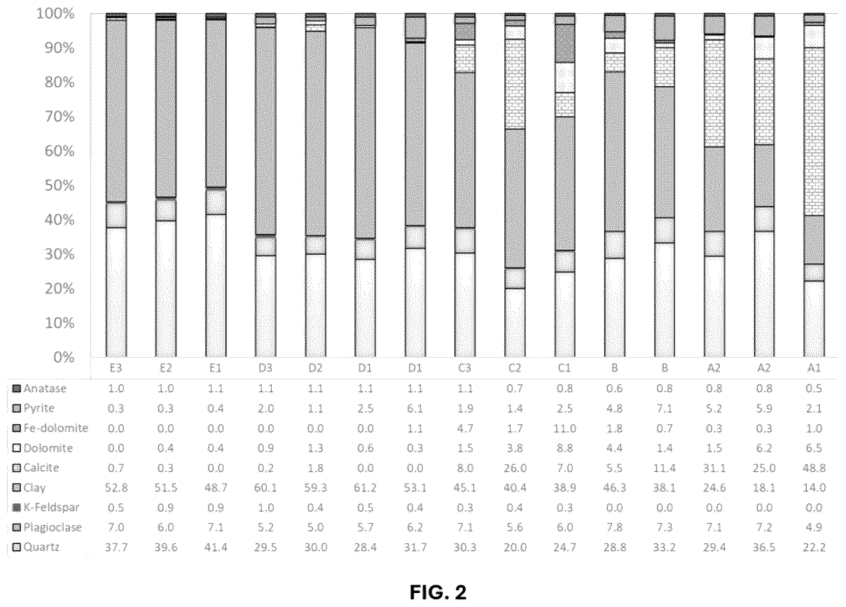

FIG. 1 shows representative map data of US sedimentary basins and their relative lithium content.

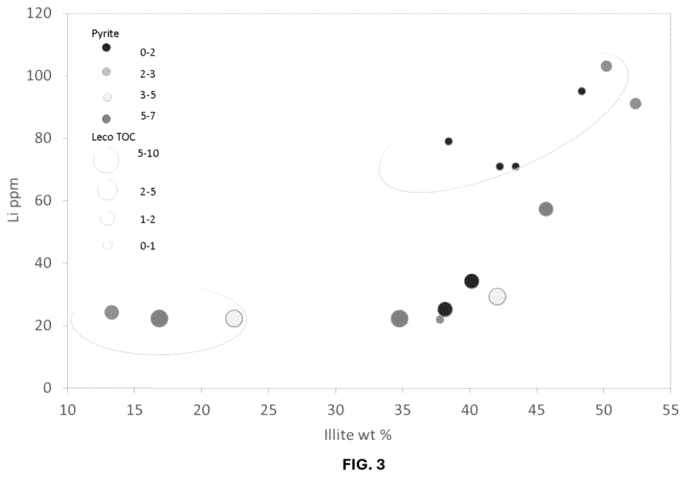

FIG. 2 shows representative data pertaining to XRD-determined mineralogy of 15 Mid-Devonian samples. Samples labeled C1, C2, A1, and A2 are carbonate-dominated and relatively clay-poor, and lithium content in these samples is significantly less than others shown. Without wishing to be bound by a particular theory, it is believed the lower levels are associated with carbonate dilution.

FIG. 3 shows representative data pertaining to correlation between illite and whole rock Li content. The size of the circles corresponds to the TOC content, and the colors indicate the magnitude of pyrite.

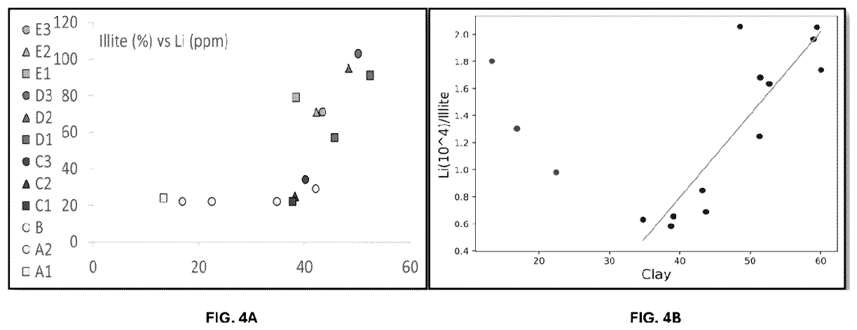

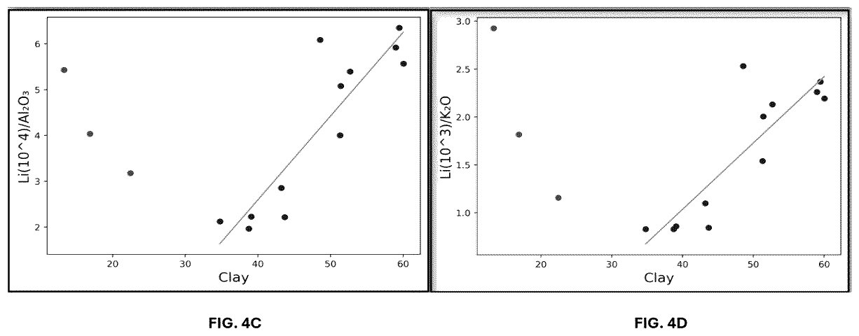

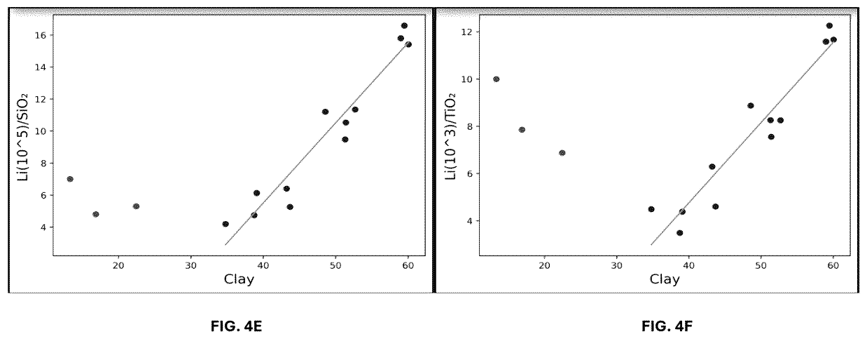

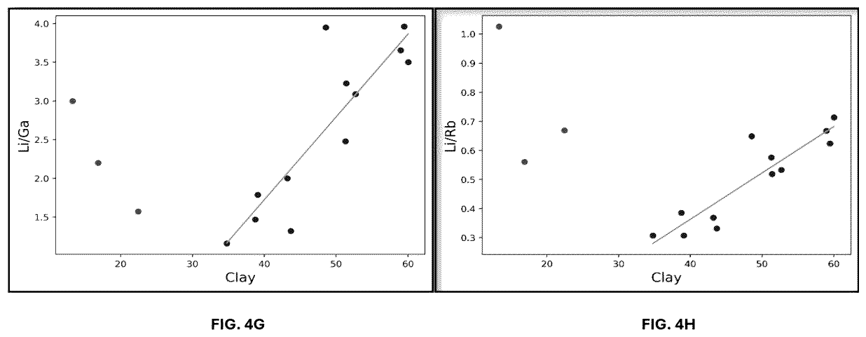

FIGS. 4A-4H show representative scatter plot data showing relationship of lithium with clay fractions when normalized to the clay and silicate-indicators, namely illite, SiO2, Al2O3, K2O, TiO2, Rb, and Ga. The three orange circles correspond to the 3 bottom-most horizons namely the carbonate-dominated A1 and A2 samples. FIG. 4A shows illite percent (% illite; y-axis) versus Li (ppm; x-axis) for the indicated samples, i.e., A1, A2, B, C1-C3, D1-D3, and E1-E3 (as further described herein below in Examples). FIG. 4B shows normalized value of lithium (ppm lithium converted to % lithium and divided by illite percent) versus clay content (x-axis; % clay) for the indicated samples. FIG. 4C shows normalized value of (ppm lithium converted to % lithium and divided by AL2O3 percent) versus clay content (x-axis; % clay) for the indicated samples. FIG. 4D shows normalized value of (ppm lithium converted to % lithium and divided by K2O percent) versus clay content (x-axis; % clay) for the indicated samples. FIG. 4E shows normalized value of (ppm lithium converted to % lithium and divided by SiO2 percent) versus SiO2 content (x-axis; % clay) for the indicated samples. FIG. 4F shows normalized value of (ppm lithium converted to % lithium and divided by TiO2 percent) versus clay content (x-axis; % clay) for the indicated samples. FIG. 4G shows normalized lithium (y-axis; Li ppm divided by Ga ppm) versus clay content (x-axis; % clay) for the indicated samples. FIG. 4H shows normalized lithium (Li ppm divided by Rb ppm) versus clay content (x-axis; % clay) for the indicated samples.

FIG. 5 shows representative data for dissolved Li concentrations in the sequentially extracted leachates, acid-soluble (green), Fe—Mn (oxy) hydroxides (yellow), organics (red), and pyrite (blue-grey).

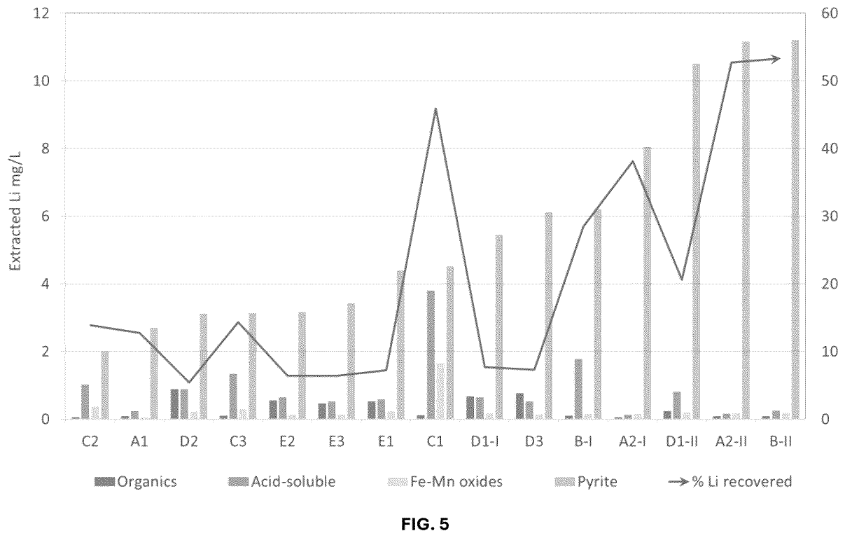

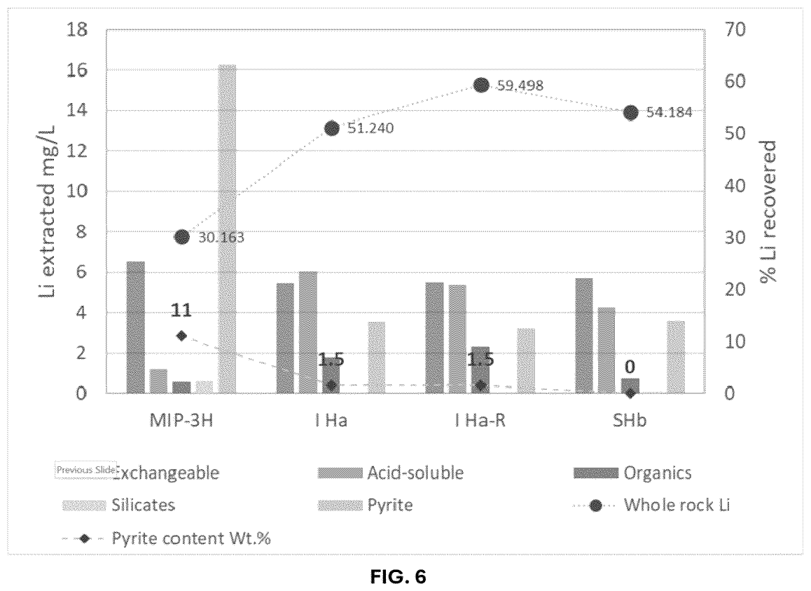

FIG. 6 shows representative data for dissolved Li concentrations in the sequentially extracted leachates of 2 Haynesville and 1 Marcellus samples.

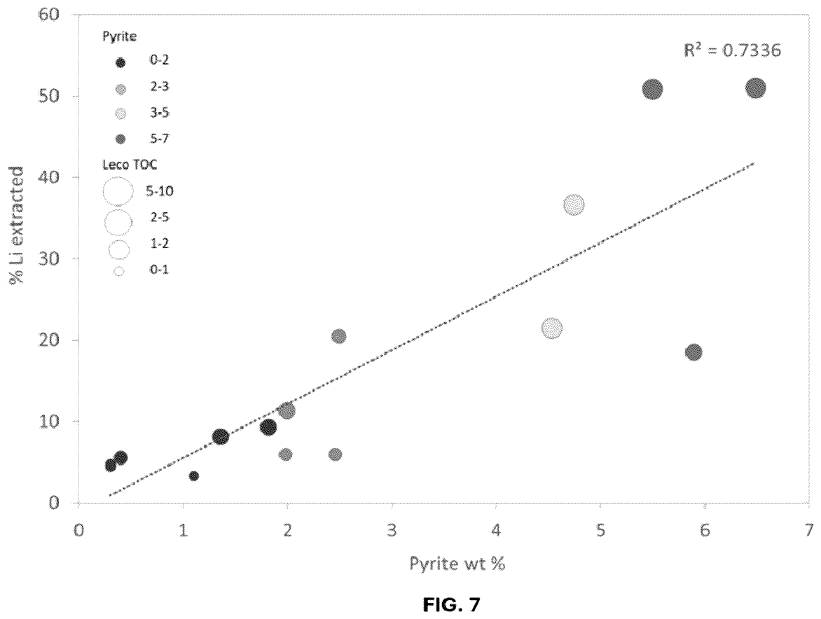

FIG. 7 shows representative data for correlation between illite and whole rock Li content. The size of the circles corresponds to the TOC content and the colors indicate the magnitude of pyrite.

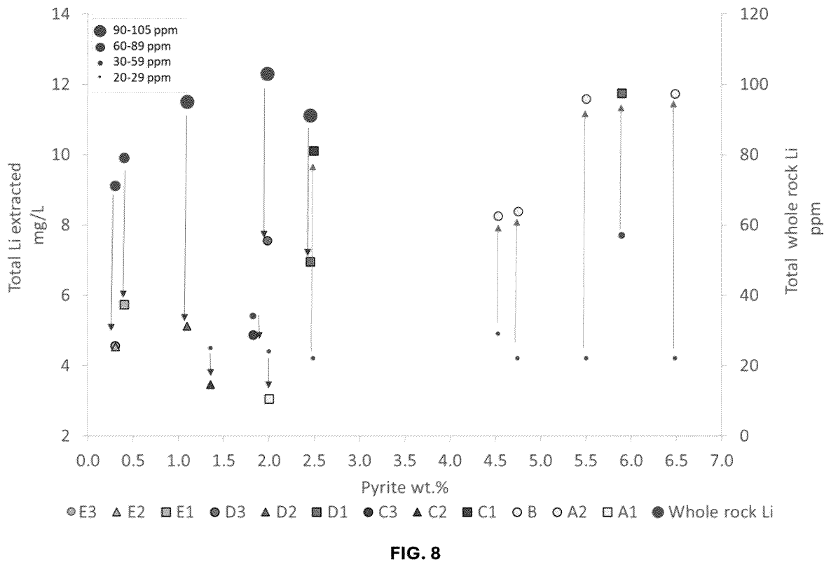

FIG. 8 shows representative data pertaining to relationship between XRD-determined pyrite fraction, total extracted Li (left vertical axis) indicated by colored symbols representing each formation, and whole rock Li (right vertical axis) indicated by blue-grey solid circles. The downward-pointing red arrows indicate that the extracted Li concentration of that sample is less than the bulk Li content. The upward-pointing blue arrows indicate that the extracted Li concentration of that sample is more than the bulk Li content.

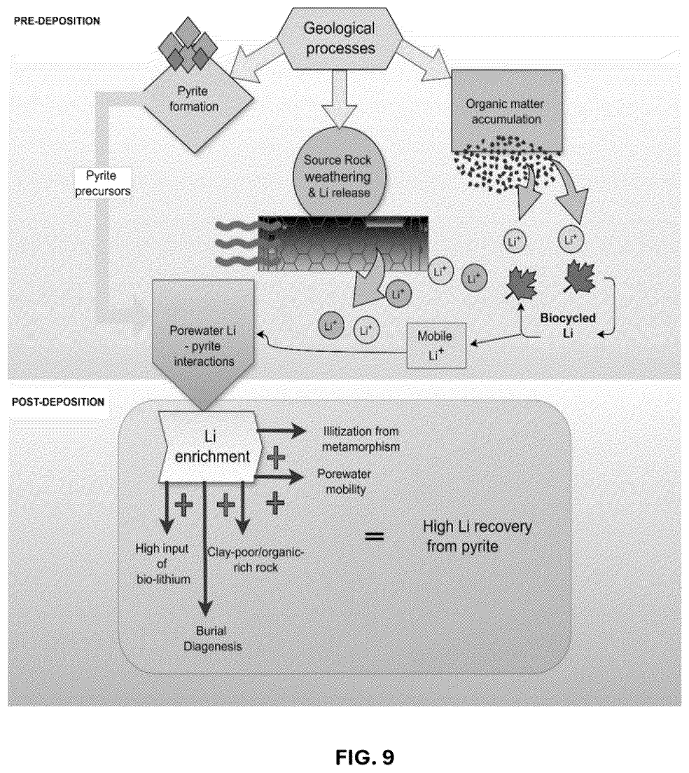

FIG. 9 shows a representative schematic flow diagram of a disclosed leaching process for treatment of an organic-rich shale to provide lithium

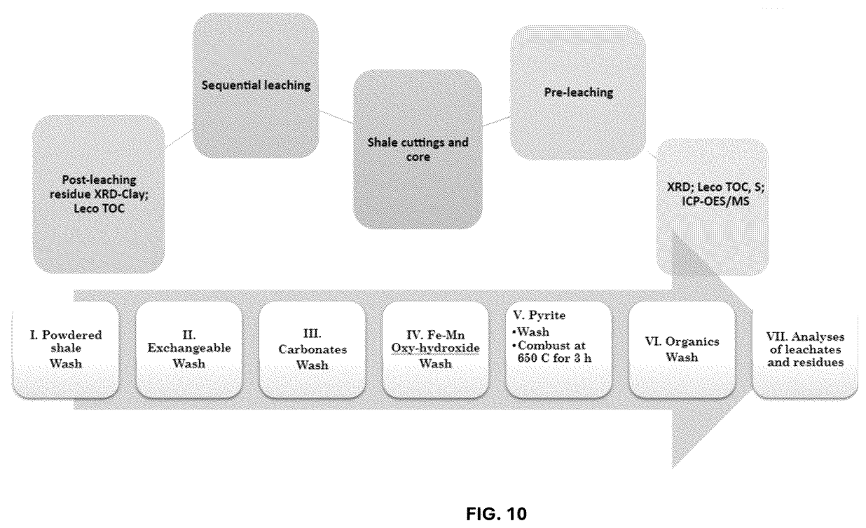

FIG. 10 shows a representative schematic flow diagram of a disclosed leaching process for treatment of an organic-rich shale to provide lithium.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a critical mineral,” “an acid,” or “a reducing agent,” includes, but is not limited to, two or more such critical minerals, acids, or reducing agents, and the like.

Reference to “a/an” chemical compound, protein, and antibody each refers to one or more molecules of the chemical compound, protein, and antibody rather than being limited to a single molecule of the chemical compound, protein, and antibody. Furthermore, the one or more molecules may or may not be identical, so long as they fall under the category of the chemical compound, protein, and antibody.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “organic-rich shale” or “black shale” refers to shale, a sedimentary rock, that has a total organic carbon content of at least 0.5 wt %. Black shales are dark-colored, usually thinly laminated mudstones containing appreciable organic matter (>0.5 wt % C), authigenic iron sulfides, and silt-sized and clay-sized detrital particles that in most cases have been accumulated under anoxic bottom water and/or bottom sediment conditions in marine or continental sedimentary basins (Skinner, 1993; Wignall, 1994; Kontinen and Hanski, 2015)

“Critical minerals” (CMs) as used herein include minerals important to national security and the economy. CMs are considered critical due to their numerous industrial uses. As used in the context of the present disclosure, certain CMs may also be purified and concentrated using the disclosed process and include one or more of the non-rare earth elements selected from cobalt, gallium, germanium, hafnium, indium, lithium, magnesium, manganese, nickel, niobium, rubidium, tantalum, tellurium, and zinc. However, the foregoing is merely exemplary, and additional or alternative CMs may be obtained. It should be noted that the U.S. Geological Survey regularly makes a determination of minerals critical to the U.S. economy, with the last list having been made publicly available on or about Feb. 22, 2022 (e.g., see Federal Register, Vol. 87, No. 37, Thursday, Feb. 24, 2022, p. 10381-10382, last accessed Sep. 17, 2024; which is incorporated by reference). As used in the context of the present disclosure, a CM may further include one or more mineral identified in the U.S. Geological Survey.

As used herein, the term “shale particulate composition” refers to a powdered or granulated form of organic-rich shale that may be produced by homogenizing a raw sample of shale through processes including drying, crushing, splitting, and/or pulverizing to achieve a target grain or particle size. The shale particulate composition may have a grain size ranging from about 50 μm to about 100 μm, and in some aspects may have a grain size of about 75 μm.

As used herein, the term “total organic carbon” or “TOC” refers to the amount of carbon found in organic compounds present in the shale sample, expressed as a weight percentage. The TOC content may be used as an indicator of the organic richness of the shale and may influence the extraction efficiency of critical minerals.

As used herein, the term “sequential leaching” refers to a multi-step extraction process wherein different chemical treatments are applied in a specific order to selectively dissolve and extract different mineral phases or components from the shale particulate composition. Each step may target specific mineralogical fractions such as exchangeable ions, carbonates, oxides, sulfides, or organic matter-bound minerals.

As used herein, the term “leachate” refers to the liquid solution containing dissolved minerals and other components that results from the treatment of solid material with an extracting solution. The leachate may contain one or more extracted critical minerals in dissolved form.

As used herein, the term “retentate” refers to the solid material that remains after filtration or separation, which retains the undissolved components of the original sample.

As used herein, the term “reducing agent solution” refers to a chemical solution containing one or more reducing agents capable of donating electrons to other substances, thereby reducing them. The reducing agent solution may include compounds such as hydroxylamine hydrochloride, sodium sulfite, ascorbic acid, or sodium ascorbate, and may further comprise an acid component to maintain appropriate pH conditions.

As used herein, the term “mineral acid” refers to an inorganic acid derived from one or more inorganic compounds. Examples of mineral acids that may be used in the disclosed methods include nitric acid, hydrochloric acid, and sulfuric acid. The mineral acid may be used to dissolve sulfide minerals and extract critical minerals associated with organic matter.

As used herein, the term “pyrite” refers to an iron sulfide mineral with the chemical formula FeS₂. Pyrite may be present in organic-rich shales and may serve as a host for critical minerals, particularly lithium, making it a target phase for extraction in the disclosed methods.

As used herein, the term “illite” refers to a group of closely related non-expanding clay minerals that may be formed through the alteration of other clay minerals during diagenesis. Illite may be associated with critical mineral content in shales and may influence the distribution and extractability of these minerals.

As used herein, the term “extraction efficiency” refers to the percentage of a target critical mineral that is successfully recovered from the original shale sample through the sequential leaching process. The extraction efficiency may be calculated as the ratio of extracted mineral content to the total mineral content present in the original sample.

Unless otherwise specified, temperatures referred to herein are based on atmospheric pressure (i.e. one atmosphere).

### B. ABBREVIATIONS

OM organic matter
TOC total organic carbon
XRD X-Ray diffraction

### C. INTRODUCTION

The demand for clean energy technologies that produce, transmit, store, and/or conserve energy is increasing. This includes technologies such as high-energy density batteries. (Choi et al., 2020; Zhou et al., 2022). To meet the high demand for alternative energy materials, lithium-ion batteries have been more appealing than other rechargeable systems. The current global Li reserves are estimated to be 210 million tons, besides other sources such as brines from geothermal, continental, and oilfield basins, contributing up to 78 million tons (Adeel et al., 2023). However, projected calculations indicate that production will peak by 2041, thus exacerbating the Li supply crisis. This impending supply shortage creates an urgent need for alternative lithium sources and more efficient extraction methods to meet the growing demand for clean energy technologies.

Many geological systems remain relatively underexplored in terms of Li. The upper continental crust has an average Li content of around 35 ppm±11 ppm (see McLennan 2001 or 2009; and Teng et al., 2004). The most well-known sources of Li are pegmatites (Karrech et al., 2020; Bowell et al., 2020; D Silva et al., 2023), volcanic tuff (Ellis et al., 2018, Castor and Henry, 2020), Li-rich micas (Sokolova et al., 2011; Canosa et al., 2012; Chicharro et al., 2016; Wu et al., 2017; Monnier et al., 2022), and several continental brine sources (Dugamin et al., 2021; 2023). However, these conventional sources face significant challenges including geographic concentration, depletion of high-grade deposits, environmental concerns, and geopolitical supply chain vulnerabilities. Organic-rich shales, mudstones, and oil shales are also often enriched with Li with a median value of 45 ppm FIG. 1 (Farrell et al., 2021). However, little is known about the geochemical association of Li within the oxidizing fractions of shale, particularly pyrite (Milliken et al., 2013 [16]; Kohl et al., 2014 [17]; Lash and Blood, 2014 [18]; Phan et al., 2016). This knowledge gap has limited the development of effective extraction methods for these potentially abundant and widely distributed lithium resources.

In one aspect, the disclosure relates to methods for extracting critical minerals from organic-rich shale (i.e., black shale). More specifically, in one aspect, the present disclosure relates to methods for extracting critical minerals from a sedimentary particulate composition using a series of treatment steps that can extract various organic and/or inorganic materials from the composition. The disclosed sequential leaching approach addresses the aforementioned problems by providing a systematic method to selectively target different mineralogical phases in organic-rich shales, including the previously unexploited pyrite-associated lithium reserves. In one aspect, the extraction methods disclosed herein can target Li extraction from sedimentary rock feedstock, such as organic-rich shale. The methods can be used to extract Li from oilfield brines, geothermal brines, and possibly other continental brines, as well as improve upon current Li extraction methods in these respective fields. By providing an economically viable method to extract lithium from widely available organic-rich shales, the present disclosure offers a solution to diversify lithium supply sources and reduce dependence on conventional deposits that are subject to supply chain disruptions.

### D. METHODS FOR CRITICAL MINERAL EXTRACTION

In one aspect, disclosed herein is a method comprising: providing a shale particulate composition comprising a total organic carbon content of at least 0.5 wt % and at least one critical mineral; mixing the shale particulate composition with water, thereby forming a slurry; filtering the slurry, thereby forming a shale particulate retentate and a first filtrate; mixing the shale particulate retentate and a magnesium chloride solution, thereby forming a magnesium chloride slurry comprising a first solid and a first leachate; mixing the first solid with a first acid, thereby forming an organic acid slurry comprising a second solid and a second leachate; mixing the second solid with a reducing agent solution, thereby forming a reduced slurry comprising a third solid and a third leachate; and mixing the third solid with a mineral acid, thereby forming a mineral acid slurry comprising a stripped solid and a final leachate; wherein the final leachate comprises at least one extracted critical mineral.

The shale particulate composition can comprise organic-rich or black shale. In one aspect, the shale particulate composition is a powdered shale that can be produced by homogenizing a raw sample of shale. Homogenizing can include steps of drying, crushing, splitting, and/or pulverizing to a target grain or particle size. In one aspect, the shale particulate composition can comprise a grain size of about 75 μm. In a further aspect, the is from about 50 μm to 100 μm.

In a further aspect, the shale particulate composition can have a TOC content of at least about 2 wt %, at least about 3 wt %, at least about 4 wt %, at least about 5 wt %, or at least about 6 wt %. In another further aspect, the shale particulate composition can include a TOC content of about 0.5 wt % to about 20 wt %, about 2 wt % to about 20 wt %, about 3 wt % to about 20 wt %, about 4 wt % to about 20 wt %, or about 5 wt % to about 20 wt %. In another aspect, the shale particulate composition can include a pyrite content of at least about 2.5 wt %, at least about 4 wt %, at least about 5 wt %, or at least about 6 wt %. In another aspect, the shale particulate composition can include a pyrite content of about 3 wt % to about 20 wt % or about 5 wt % to about 20 wt %.

In one aspect, the shale particulate composition can comprise the critical mineral lithium. In another aspect, the extracted critical mineral in the final leachate can comprise the critical mineral lithium. At least 20%, at least 30%, at least 40%, at least 50%, or at least 60% of the total lithium contained in the shale particulate composition can be extracted in the final leachate. In another aspect, the final leachate can comprise from about 20% to about 99%, about 20% to about 90%, about 20% to about 80%, about 20% to about 70%, about 30% to about 99%, about 30% to about 90%, about 30% to about 80%, or about 30% to about 70% of the total lithium contained in the shale particulate composition.

In one aspect, the slurry can be formed by mixing or washing the shale particulate composition with water. The mixture or slurry of shale particulate composition and water can be agitated, such as be stirring (e.g., using a magnetic or mechanical stirrer) or shaking (e.g., using a plate or orbital shaker). In one aspect, the mixture or slurry can be agitated for about 6 hours to about 36 hours, about 6 hours to about 48 hours, about 6 hours to about 60 hours, about 6 hours to about 72 hours, about 6 hours to about 84 hours, about 6 hours to about 96 hours, about 12 hours to about 36 hours, about 12 hours to about 48 hours, about 12 hours to about 60 hours, about 12 hours to about 72 hours, about 18 hours to about 84 hours, about 12 hours to about 96 hours about 12 hours to about 36 hours, about 12 hours to about 48 hours, about 18 hours to about 60 hours, about 12 hours to about 72 hours, about 12 hours to about 84 hours, about 12 hours to about 96 hours, about 24 hours to about 36 hours, about 24 hours to about 48 hours, about 24 hours to about 60 hours, about 24 hours to about 72 hours, about 24 hours to about 84 hours, about 24 hours to about 96 hours.

In one aspect, the magnesium chloride solution and the shale particulate retentate can be mixed at a weight ratio of about 10:1 to about 6:1 or about 9:1 to about 7:1 (magnesium chloride solution:shale particulate retentate). In a further aspect, the magnesium chloride solution may further comprise one or more of calcium chloride, potassium chloride, and/or sodium chloride. In a still further aspect, the magnesium chloride solution may be replaced by a calcium chloride solution, potassium chloride solution, sodium chloride solution, or mixtures thereof. The magnesium chloride solution can have a concentration of magnesium chloride of about 0.5 M to about 2.0 M or about 0.75 M to about 1.50 M.

In one aspect, the first acid and the first solid can be mixed at a weight ratio of about 20:1 to about 10:1 or about 9:1 to about 7:1 (first acid:first solid). The first acid can comprise hydrochloric acid, acetic acid, formic acid, citric acid, oxalic acid, or any combination thereof. The first acid can have a concentration of about 0.5 M to about 2.0 M or about 0.75 M to about 1.50 M.

In one aspect, the reducing agent solution and the second solid can be mixed at a weight ratio of about 20:1 to about 10:1 or about 18:1 to about 13:1 (reducing agent solution:second solid). The reducing agent solution can include a reducing agent and a second acid. An exemplary, but non-limiting, is that reducing agent can be selected from hydroxylamine hydrochloride, sodium sulfite, ascorbic acid, sodium ascorbate, or any combination thereof. In a further aspect, the reducing agent comprises hydroxylamine hydrochloride. The concentration of the reducing agent in the reducing agent solution can range from about 0.01 M to about 0.10 M or about 0.02 M to about 0.08 M. The second acid can include acetic acid, formic acid, citric acid, oxalic acid, or any combination thereof. The reducing agent solution can comprise from about 15% to about 35% or about 20% to about 30% acetic acid. In another aspect, the pH of the reducing agent solution or of the reduced slurry can be from about 1.0 to about 3.0 or about 1.5 to about 2.5.

In one aspect, the mineral acid and the third solid can be mixed at a weight ratio of about 20:1 to about 10:1 or about 18:1 to about 13:1 (mineral acid:third solid). The mineral acid can include nitric acid, hydrochloric acid, sulfuric acid, or any combination thereof. In a further aspect, the mineral acid comprises nitric acid. In a still further aspect, the mineral acid can further comprise an oxidizing agent such as ferric chloride or a reducing agent such as a chromous chloride/zinc acetate trap. In a yet further aspect, the mineral acid can be omitted and replaced with an oxidizing agent such as ferric chloride or a reducing agent such chromous chloride in a zinc acetate trap. The mineral acid can have a concentration of from about 1.0 M to about 3.0 M or about 1.5 M to about 2.5 M. The mixture or slurry of the third solid and the mineral acid can be agitated, such as be stirring (e.g., using a magnetic or mechanical stirrer) or shaking (e.g., using a plate or orbital shaker). In one aspect, the mixture or slurry can be agitated for about 6 hours to about 36 hours, about 6 hours to about 48 hours, about 6 hours to about 60 hours, about 6 hours to about 72 hours, about 6 hours to about 84 hours, about 6 hours to about 96 hours, about 12 hours to about 36 hours, about 12 hours to about 48 hours, about 12 hours to about 60 hours, about 12 hours to about 72 hours, about 18 hours to about 84 hours, about 12 hours to about 96 hours about 12 hours to about 36 hours, about 12 hours to about 48 hours, about 18 hours to about 60 hours, about 12 hours to about 72 hours, about 12 hours to about 84 hours, about 12 hours to about 96 hours, about 24 hours to about 36 hours, about 24 hours to about 48 hours, about 24 hours to about 60 hours, about 24 hours to about 72 hours, about 24 hours to about 84 hours, about 24 hours to about 96 hours.

In one aspect, disclosed herein is a method comprising: providing a shale particulate composition comprising a total organic carbon content of at least 0.5 wt % and at least one critical mineral; mixing the shale particulate composition with water, thereby forming a slurry; filtering the slurry, thereby forming a shale particulate retentate and a first filtrate; mixing the shale particulate retentate and a magnesium chloride solution, thereby forming a magnesium chloride slurry comprising a first solid and a first leachate; mixing the first solid with a first acid, thereby forming an organic acid slurry comprising a second solid and a second leachate; mixing the second solid with a reducing agent solution, thereby forming a reduced slurry comprising a third solid and a third leachate; and mixing the third solid with a mineral acid, thereby forming a mineral acid slurry comprising a stripped solid and a final leachate; wherein the final leachate comprises at least one extracted critical mineral.

The shale particulate composition can comprise organic-rich or black shale. In one aspect, the shale particulate composition is a powdered shale that can be produced by homogenizing a raw sample of shale. Homogenizing can include steps of drying, crushing, splitting, and/or pulverizing to a target grain or particle size. In one aspect, the shale particulate composition can comprise a grain size of about 75 μm. In a further aspect, the grain size is from about 50 μm to 100 μm.

In a further aspect, the shale particulate composition can have a TOC content of at least about 2 wt %, at least about 3 wt %, at least about 4 wt %, at least about 5 wt %, or at least about 6 wt %. In another further aspect, the shale particulate composition can include a TOC content of about 0.5 wt % to about 20 wt %, about 2 wt % to about 20 wt %, about 3 wt % to about 20 wt %, about 4 wt % to about 20 wt %, or about 5 wt % to about 20 wt %. In another aspect, the shale particulate composition can include a pyrite content of at least about 2.5 wt %, at least about 4 wt %, at least about 5 wt %, or at least about 6 wt %. In another aspect, the shale particulate composition can include a pyrite content of about 3 wt % to about 20 wt % or about 5 wt % to about 20 wt %.

In one aspect, the shale particulate composition can comprise the critical mineral lithium. In another aspect, the extracted critical mineral in the final leachate can comprise the critical mineral lithium. At least 20%, at least 30%, at least 40%, at least 50%, or at least 60% of the total lithium contained in the shale particulate composition can be extracted in the final leachate. In another aspect, the final leachate can comprise from about 20% to about 99%, about 20% to about 90%, about 20% to about 80%, about 20% to about 70%, about 30% to about 99%, about 30% to about 90%, about 30% to about 80%, or about 30% to about 70% of the total lithium contained in the shale particulate composition.

In one aspect, the slurry can be formed by mixing or washing the shale particulate composition with water. The mixture or slurry of shale particulate composition and water can be agitated, such as by stirring (e.g., using a magnetic or mechanical stirrer) or shaking (e.g., using a plate or orbital shaker). In one aspect, the mixture or slurry can be agitated for about 6 hours to about 36 hours, about 6 hours to about 48 hours, about 6 hours to about 60 hours, about 6 hours to about 72 hours, about 6 hours to about 84 hours, about 6 hours to about 96 hours, about 12 hours to about 36 hours, about 12 hours to about 48 hours, about 12 hours to about 60 hours, about 12 hours to about 72 hours, about 18 hours to about 84 hours, about 12 hours to about 96 hours, about 24 hours to about 36 hours, about 24 hours to about 48 hours, about 24 hours to about 60 hours, about 24 hours to about 72 hours, about 24 hours to about 84 hours, or about 24 hours to about 96 hours. In a further aspect, the water can be deionized water or distilled water. In another aspect, the water washing step can be performed at ambient temperature or at an elevated temperature of about 25° C. to about 80° C., about 30° C. to about 70° C., or about 40° C. to about 60° C. The water washing step serves to remove water-soluble salts and readily exchangeable ions from the shale particulate composition.

In one aspect, the magnesium chloride solution and the shale particulate retentate can be mixed at a weight ratio of about 10:1 to about 6:1 or about 9:1 to about 7:1 (magnesium chloride solution:shale particulate retentate). In a further aspect, the magnesium chloride solution may further comprise one or more of calcium chloride, potassium chloride, and/or sodium chloride. In a still further aspect, the magnesium chloride solution may be replaced by a calcium chloride solution, potassium chloride solution, sodium chloride solution, or mixtures thereof. The magnesium chloride solution can have a concentration of magnesium chloride of about 0.5 M to about 2.0 M or about 0.75 M to about 1.50 M. In another aspect, the magnesium chloride treatment can be performed at ambient temperature or at an elevated temperature of about 25° C. to about 80° C., about 30° C. to about 70° C., or about 40° C. to about 60° C. The magnesium chloride treatment step targets the extraction of exchangeable cations and carbonate-bound minerals.

In one aspect, the first acid and the first solid can be mixed at a weight ratio of about 20:1 to about 10:1 or about 18:1 to about 12:1 (first acid:first solid). The first acid can comprise hydrochloric acid, acetic acid, formic acid, citric acid, oxalic acid, or any combination thereof. The first acid can have a concentration of about 0.5 M to about 2.0 M or about 0.75 M to about 1.50 M. In a further aspect, the first acid treatment can be performed at ambient temperature or at an elevated temperature of about 25° C. to about 80° C., about 30° C. to about 70° C., or about 40° C. to about 60° C. In another aspect, the first acid treatment can be agitated for about 1 hour to about 24 hours, about 2 hours to about 12 hours, or about 4 hours to about 8 hours. The first acid treatment step targets the dissolution of acid-soluble phases including carbonates and some oxide minerals.

In one aspect, the reducing agent solution and the second solid can be mixed at a weight ratio of about 20:1 to about 10:1 or about 18:1 to about 13:1 (reducing agent solution:second solid). The reducing agent solution can include a reducing agent and a second acid. The reducing agent can be selected from hydroxylamine hydrochloride, sodium sulfite, ascorbic acid, sodium ascorbate, or any combination thereof. In a further aspect, the reducing agent comprises hydroxylamine hydrochloride. The concentration of the reducing agent in the reducing agent solution can range from about 0.01 M to about 0.10 M or about 0.02 M to about 0.08 M. The second acid can include acetic acid, formic acid, citric acid, oxalic acid, or any combination thereof. The reducing agent solution can comprise from about 15% to about 35% or about 20% to about 30% acetic acid. In another aspect, the pH of the reducing agent solution or of the reduced slurry can be from about 1.0 to about 3.0 or about 1.5 to about 2.5. In a further aspect, the reducing agent treatment can be performed at ambient temperature or at an elevated temperature of about 25° C. to about 80° C., about 30° C. to about 70° C., or about 40° C. to about 60° C. In another aspect, the reducing agent treatment can be agitated for about 1 hour to about 24 hours, about 2 hours to about 12 hours, or about 4 hours to about 8 hours. The reducing agent treatment step targets the dissolution of reducible phases including iron and manganese oxides and hydroxides.

In one aspect, the mineral acid and the third solid can be mixed at a weight ratio of about 20:1 to about 10:1 or about 18:1 to about 13:1 (mineral acid:third solid). The mineral acid can include nitric acid, hydrochloric acid, sulfuric acid, or any combination thereof. In a further aspect, the mineral acid comprises nitric acid. In a still further aspect, the mineral acid can further comprise an oxidizing agent such as ferric chloride or a reducing agent such as a chromous chloride/zinc acetate trap. In a yet further aspect, the mineral acid can be omitted and replaced with an oxidizing agent such as ferric chloride or a reducing agent such as chromous chloride in a zinc acetate trap. The mineral acid can have a concentration of from about 1.0 M to about 3.0 M or about 1.5 M to about 2.5 M. The mixture or slurry of the third solid and the mineral acid can be agitated, such as by stirring (e.g., using a magnetic or mechanical stirrer) or shaking (e.g., using a plate or orbital shaker). In one aspect, the mixture or slurry can be agitated for about 6 hours to about 36 hours, about 6 hours to about 48 hours, about 6 hours to about 60 hours, about 6 hours to about 72 hours, about 6 hours to about 84 hours, about 6 hours to about 96 hours, about 12 hours to about 36 hours, about 12 hours to about 48 hours, about 12 hours to about 60 hours, about 12 hours to about 72 hours, about 18 hours to about 84 hours, about 12 hours to about 96 hours, about 24 hours to about 36 hours, about 24 hours to about 48 hours, about 24 hours to about 60 hours, about 24 hours to about 72 hours, about 24 hours to about 84 hours, or about 24 hours to about 96 hours. In a further aspect, the mineral acid treatment can be performed at ambient temperature or at an elevated temperature of about 25° C. to about 100° C., about 40° C. to about 90° C., or about 60° C. to about 80° C. The mineral acid treatment step targets the dissolution of sulfide minerals, particularly pyrite, and organic matter-bound critical minerals.

In another aspect, each of the filtering steps can be performed using filtration methods known in the art, including but not limited to vacuum filtration, pressure filtration, centrifugation, or gravity filtration. In a further aspect, the filtering can be performed using filter paper, membrane filters, or other suitable filtration media with pore sizes ranging from about 0.1 μm to about 10 μm, about 0.2 μm to about 5 μm, or about 0.45 μm to about 2 μm.

In yet another aspect, the method can further comprise washing each solid residue between treatment steps with deionized water to remove residual treatment solutions and prevent cross-contamination between sequential extraction steps. In a further aspect, the washing can be performed using a volume of deionized water equal to about 2 to about 10 times, about 3 to about 8 times, or about 4 to about 6 times the volume of the treatment solution used in the preceding step.

In a further aspect, the method can comprise additional pre-treatment steps prior to the water washing step, including thermal treatment of the shale particulate composition at temperatures ranging from about 100° C. to about 300° C., about 150° C. to about 250° C., or about 180° C. to about 220° C. for about 1 hour to about 12 hours to enhance the liberation of critical minerals from the organic matrix. In another aspect, the pre-treatment can include microwave-assisted heating at frequencies of about 2.4 GHz to about 5.8 GHz for about 5 minutes to about 60 minutes to increase the porosity and accessibility of critical minerals within the shale matrix.

In yet another aspect, the method can further comprise ultrasonic treatment during one or more of the mixing steps, wherein ultrasonic energy is applied at frequencies ranging from about 20 KHz to about 100 kHz, about 35 kHz to about 80 kHz, or about 40 kHz to about 60 KHz for about 10 minutes to about 120 minutes to enhance mass transfer and extraction efficiency. The ultrasonic treatment can be applied with power densities ranging from about 50 W/L to about 500 W/L or about 100 W/L to about 300 W/L.

In another aspect, the sequential extraction process can be modified to include additional intermediate steps, such as an enzymatic treatment step between the first acid treatment and the reducing agent treatment, wherein enzymes selected from cellulases, hemicellulases, lignin peroxidases, or combinations thereof are used to break down organic matter and release organically-bound critical minerals. The enzymatic treatment can be performed at temperatures ranging from about 30° C. to about 70° C., about 40° C. to about 60° C., or about 45° C. to about 55° C., and at pH values ranging from about 4.0 to about 8.0, about 5.0 to about 7.0, or about 5.5 to about 6.5.

In a further aspect, the method can include pressure-assisted extraction, wherein one or more of the treatment steps are performed under elevated pressure ranging from about 2 bar to about 20 bar, about 5 bar to about 15 bar, or about 8 bar to about 12 bar to enhance the penetration of treatment solutions into the shale matrix and improve extraction kinetics.

In another aspect, the method can comprise the use of chelating agents in combination with one or more of the treatment solutions, wherein the chelating agents are selected from ethylenediaminetetraacetic acid (EDTA), nitrilotriacetic acid (NTA), diethylenetriaminepentaacetic acid (DTPA), or combinations thereof, at concentrations ranging from about 0.001 M to about 0.1 M, about 0.005 M to about 0.05 M, or about 0.01 M to about 0.03 M to enhance the solubilization and extraction of critical minerals.

In yet another aspect, the method can include electrochemical enhancement, wherein an electric field is applied during one or more treatment steps using electrodes positioned within the treatment vessel, with applied voltages ranging from about 1 V to about 50 V, about 5 V to about 30 V, or about 10 V to about 20 V, and current densities ranging from about 0.1 A/m² to about 10 A/m² to promote the migration and extraction of ionic species.

In a further aspect, the method can comprise multiple parallel extraction pathways, wherein portions of the shale particulate composition are subjected to different sequences of treatment steps optimized for the extraction of specific critical minerals, and the resulting leachates are subsequently combined or processed separately depending on the target mineral recovery objectives.

In another aspect, the method can include the use of ionic liquids as alternative or supplementary extraction media, wherein the ionic liquids are selected from imidazolium-based, pyridinium-based, or phosphonium-based ionic liquids with anions such as chloride, bromide, acetate, or bis(trifluoromethylsulfonyl)imide, used at concentrations ranging from about 0.1 M to about 2.0 M or about 0.5 M to about 1.5 M.

In yet another aspect, the method can comprise continuous flow processing, wherein the shale particulate composition is processed in a continuous manner through a series of connected treatment vessels, with residence times in each vessel ranging from about 30 minutes to about 8 hours, about 1 hour to about 6 hours, or about 2 hours to about 4 hours, and flow rates ranging from about 0.1 L/min to about 10 L/min, about 0.5 L/min to about 5 L/min, or about 1 L/min to about 3 L/min.

In a further aspect, the method can include real-time monitoring and control of extraction parameters using sensors for pH, temperature, conductivity, and dissolved mineral concentrations, with automated feedback control systems that adjust treatment conditions to optimize extraction efficiency and maintain target parameter ranges throughout the process.

In another aspect, the method can comprise the recovery and recycling of treatment solutions, wherein spent treatment solutions are regenerated through processes such as solvent extraction, ion exchange, precipitation, or electrochemical recovery, allowing for the reuse of treatment chemicals and reducing overall process costs and environmental impact.

### E. ASPECTS

The following listing of exemplary aspects supports and is supported by the disclosure provided herein.

Aspect 1. A method, comprising: providing a shale particulate composition comprising a total organic carbon content of at least 0.5 wt % and at least one critical mineral; mixing the shale particulate composition with water, thereby forming a slurry; filtering the slurry, thereby forming a shale particulate retentate and a first filtrate; mixing the shale particulate retentate and a magnesium chloride solution, thereby forming a magnesium chloride slurry comprising a first solid and a first leachate; mixing the first solid with a first acid, thereby forming an organic acid slurry comprising a second solid and a second leachate; mixing the second solid with a reducing agent solution, thereby forming a reduced slurry comprising a third solid and a third leachate; and mixing the third solid with a mineral acid, thereby forming a mineral acid slurry comprising a stripped solid and a final leachate; wherein the final leachate comprises at least one extracted critical mineral.

Aspect 2. The method of aspect 1, wherein the slurry is agitated prior to filtering.

Aspect 3. The method of aspect 2, wherein the slurry is agitated for about 10 hours to about 30 hours.

Aspect 4. The method of any one of aspects 1-3, wherein the magnesium chloride solution and the shale particulate retentate are mixed at a weight ratio of about 10:1 to about 6:1 (magnesium chloride solution:shale particulate retentate).

Aspect 5. The method of any one of aspects 1-4, wherein the magnesium chloride solution has a concentration of magnesium chloride of about 0.5 M to about 2.0 M.

Aspect 6. The method of any one of aspects 1-5, wherein the first acid and the first solid are mixed at a weight ratio of about 20:1 to about 10:1 (first acid:first solid).

Aspect 7. The method of any one of aspects 1-6, wherein the first acid comprises hydrochloric acid, acetic acid, formic acid, citric acid, oxalic acid, or any combination thereof.

Aspect 8. The method of any one of aspects 1-7, wherein the first acid has a concentration of about 0.5 M to about 2.0 M.

Aspect 9. The method of any one of aspects 1-8, wherein the reducing agent solution and the second solid are mixed at a weight ratio of about 20:1 to about 10:1 (reducing agent solution:second solid).

Aspect 10. The method of any one of aspects 1-9, wherein the reducing agent solution comprises a reducing agent and a second acid.

Aspect 11. The method of aspect 10, wherein the reducing agent is hydroxylamine hydrochloride, sodium sulfite, ascorbic acid, sodium ascorbate, or any combination thereof.

Aspect 12. The method of aspect 10 or aspect 11, wherein the concentration of the reducing agent in the reducing agent solution ranges from about 0.01 M to about 0.10 M.

Aspect 13. The method of any one of aspects 10-12, wherein the second acid comprises acetic acid, formic acid, citric acid, oxalic acid, or any combination thereof.

Aspect 14. The method of any one of aspects 1-13, wherein the pH of the reduced slurry is about 1.0 to about 3.

Aspect 15. The method of any one of aspects 1-14, wherein the mineral acid and the third solid are mixed at a weight ratio of about 20:1 to about 10:1 (mineral acid:third solid).

Aspect 16. The method of any one of aspects 1-15, wherein mixing the third solid and the mineral acid further comprises agitating the third solid and the mineral acid.

Aspect 17. The method of aspect 16, wherein the third solid and the mineral acid are agitated for about 10 hours to about 30 hours.

Aspect 18. The method of any one of aspects 1-17, wherein the mineral acid comprises nitric acid, hydrochloric acid, sulfuric acid, an oxidizing agent, a reducing agent, or any combination thereof.

Aspect 19. The method of aspect 18, wherein the mineral acid comprises nitric acid.

Aspect 20. The method of aspect 18, wherein the reducing agent comprises a chromous chloride/zinc acetate trap.

Aspect 21. The method of aspect 18, wherein the oxidizing agent comprises ferric chloride.

Aspect 22. The method of any one of aspects 1-18, wherein the mineral acid has a concentration of about 1.0 M to about 2.5 M.

Aspect 23. The method of any one of aspects 1-19, wherein the shale particulate composition comprises a total organic carbon content of at least about 5 wt %.

Aspect 24. The method of any one of aspects 1-20, wherein the shale particulate composition comprises a total organic carbon content of about 5 wt % to about 20 wt %.

Aspect 25. The method of any one of aspects 1-21, wherein the shale particulate composition comprises a pyrite content of at least about 2.5 wt %.

Aspect 26. The method of any one of aspects 1-22, wherein the shale particulate composition comprises a pyrite content of about 3 wt % to about 20 wt %.

Aspect 27. The method of any one of aspects 1-23, wherein the shale particulate composition comprises a pyrite content of about 5 wt % to about 20 wt %.

Aspect 28. The method of any one of aspects 1-24, wherein the critical mineral comprises lithium.

Aspect 29. The method of any one of aspects 1-25, wherein the extracted critical mineral comprises lithium.

Aspect 30. The method of aspect 25 or 26, wherein the final leachate comprises at least about 20% of the lithium present in the shale particulate composition.

Aspect 31. The method of aspect 25 or 26, wherein the final leachate comprises at least about 30% of the lithium present in the shale particulate composition.

Aspect 32. The method of aspect 25 or 26, wherein the final leachate comprises from about 20% to about 99% of the lithium present in the shale particulate composition.

Aspect 33. The method of aspect 25 or 26, wherein the final leachate comprises from about 30% to about 99% of the lithium present in the shale particulate composition.

Aspect 34. The method of aspect 25 or 26, wherein the final leachate comprises from about 20% to about 70% of the lithium present in the shale particulate composition.

Aspect 35. The method of any one of aspects 1-34, wherein the shale particulate composition has a grain size of about 50 μm to about 100 μm.

Aspect 36. The method of any one of aspects 1-35, wherein the shale particulate composition has a grain size of about 75 μm.

Aspect 37. The method of any one of aspects 1-36, wherein the magnesium chloride solution further comprises one or more of calcium chloride, potassium chloride, and sodium chloride.

Aspect 38. The method of any one of aspects 1-37, wherein the magnesium chloride solution is replaced by a calcium chloride solution, potassium chloride solution, sodium chloride solution, or mixtures thereof.

Aspect 39. The method of any one of aspects 1-38, wherein the first acid comprises acetic acid.

Aspect 40. The method of any one of aspects 1-39, wherein the first acid has a concentration of about 0.75 M to about 1.50 M.

Aspect 41. The method of any one of aspects 1-40, wherein the reducing agent comprises hydroxylamine hydrochloride.

Aspect 42. The method of any one of aspects 1-41, wherein the concentration of the reducing agent in the reducing agent solution ranges from about 0.02 M to about 0.08 M.

Aspect 43. The method of any one of aspects 1-42, wherein the reducing agent solution comprises from about 15% to about 35% acetic acid.

Aspect 44. The method of any one of aspects 1-43, wherein the reducing agent solution comprises from about 20% to about 30% acetic acid.

Aspect 45. The method of any one of aspects 1-44, wherein the pH of the reducing agent solution is from about 1.0 to about 3.0.

Aspect 46. The method of any one of aspects 1-45, wherein the pH of the reducing agent solution is from about 1.5 to about 2.5.

Aspect 47. The method of any one of aspects 1-46, wherein the mineral acid further comprises an oxidizing agent.

Aspect 48. The method of any one of aspects 1-47, wherein the mineral acid further comprises a reducing agent.

Aspect 49. The method of any one of aspects 1-48, wherein the mineral acid is omitted and replaced with an oxidizing agent.

Aspect 50. The method of any one of aspects 1-49, wherein the mineral acid is omitted and replaced with a reducing agent.

Aspect 51. The method of any one of aspects 1-50, wherein the mineral acid has a concentration of from about 1.5 M to about 2.5 M.

Aspect 52. The method of any one of aspects 1-51, wherein the shale particulate composition comprises a total organic carbon content of at least about 2 wt %.

Aspect 53. The method of any one of aspects 1-52, wherein the shale particulate composition comprises a total organic carbon content of at least about 3 wt %.

Aspect 54. The method of any one of aspects 1-53, wherein the shale particulate composition comprises a total organic carbon content of at least about 4 wt %.

Aspect 55. The method of any one of aspects 1-54, wherein the shale particulate composition comprises a total organic carbon content of at least about 6 wt %.

Aspect 56. The method of any one of aspects 1-55, wherein the shale particulate composition comprises a total organic carbon content of about 0.5 wt % to about 20 wt %.

Aspect 57. The method of any one of aspects 1-56, wherein the shale particulate composition comprises a total organic carbon content of about 2 wt % to about 20 wt %.

Aspect 58. The method of any one of aspects 1-57, wherein the shale particulate composition comprises a total organic carbon content of about 3 wt % to about 20 wt %.

Aspect 59. The method of any one of aspects 1-58, wherein the shale particulate composition comprises a total organic carbon content of about 4 wt % to about 20 wt %.

Aspect 60. The method of any one of aspects 1-59, wherein the shale particulate composition comprises a pyrite content of at least about 4 wt %.

Aspect 61. The method of any one of aspects 1-60, wherein the shale particulate composition comprises a pyrite content of at least about 5 wt %.

Aspect 62. The method of any one of aspects 1-61, wherein the shale particulate composition comprises a pyrite content of at least about 6 wt %.

Aspect 63. The method of any one of aspects 1-62, wherein at least 20% of the total lithium contained in the shale particulate composition is extracted in the final leachate.

Aspect 64. The method of any one of aspects 1-63, wherein at least 30% of the total lithium contained in the shale particulate composition is extracted in the final leachate.

Aspect 65. The method of any one of aspects 1-64, wherein at least 40% of the total lithium contained in the shale particulate composition is extracted in the final leachate.

Aspect 66. The method of any one of aspects 1-65, wherein at least 50% of the total lithium contained in the shale particulate composition is extracted in the final leachate.

Aspect 67. The method of any one of aspects 1-66, wherein at least 60% of the total lithium contained in the shale particulate composition is extracted in the final leachate.

Aspect 68. The method of any one of aspects 1-67, wherein the final leachate comprises from about 20% to about 90% of the total lithium contained in the shale particulate composition.

Aspect 69. The method of any one of aspects 1-68, wherein the final leachate comprises from about 20% to about 80% of the total lithium contained in the shale particulate composition.

Aspect 70. The method of any one of aspects 1-69, wherein the final leachate comprises from about 30% to about 90% of the total lithium contained in the shale particulate composition.

Aspect 71. The method of any one of aspects 1-70, wherein the final leachate comprises from about 30% to about 80% of the total lithium contained in the shale particulate composition.

Aspect 72. The method of any one of aspects 1-71, wherein the final leachate comprises from about 30% to about 70% of the total lithium contained in the shale particulate composition.

Aspect 73. The method of any one of aspects 1-72, wherein the slurry is agitated for about 6 hours to about 36 hours.

Aspect 74. The method of any one of aspects 1-73, wherein the slurry is agitated for about 6 hours to about 48 hours.

Aspect 75. The method of any one of aspects 1-74, wherein the slurry is agitated for about 6 hours to about 60 hours.

Aspect 76. The method of any one of aspects 1-75, wherein the slurry is agitated for about 6 hours to about 72 hours.

Aspect 77. The method of any one of aspects 1-76, wherein the slurry is agitated for about 12 hours to about 36 hours.

Aspect 78. The method of any one of aspects 1-77, wherein the slurry is agitated for about 12 hours to about 48 hours.

Aspect 79. The method of any one of aspects 1-78, wherein the slurry is agitated for about 18 hours to about 60 hours.

Aspect 80. The method of any one of aspects 1-79, wherein the slurry is agitated for about 24 hours to about 72 hours.

Aspect 81. The method of any one of aspects 1-80, wherein the magnesium chloride solution and the shale particulate retentate are mixed at a weight ratio of about 9:1 to about 7:1 (magnesium chloride solution:shale particulate retentate).

Aspect 82. The method of any one of aspects 1-81, wherein the magnesium chloride solution has a concentration of magnesium chloride of about 0.75 M to about 1.50 M.

Aspect 83. The method of any one of aspects 1-82, wherein the first acid and the first solid are mixed at a weight ratio of about 18:1 to about 13:1 (first acid:first solid).

Aspect 84. The method of any one of aspects 1-83, wherein the reducing agent solution and the second solid are mixed at a weight ratio of about 18:1 to about 13:1 (reducing agent solution:second solid).

Aspect 85. The method of any one of aspects 1-84, wherein the mineral acid and the third solid are mixed at a weight ratio of about 18:1 to about 13:1 (mineral acid:third solid).

Aspect 86. The method of any one of aspects 1-85, wherein the third solid and the mineral acid are agitated for about 6 hours to about 36 hours.

Aspect 87. The method of any one of aspects 1-86, wherein the third solid and the mineral acid are agitated for about 6 hours to about 48 hours.

Aspect 88. The method of any one of aspects 1-87, wherein the third solid and the mineral acid are agitated for about 12 hours to about 72 hours.

Aspect 89. The method of any one of aspects 1-88, wherein the third solid and the mineral acid are agitated for about 18 hours to about 96 hours.

Aspect 90. The method of any one of aspects 1-89, wherein the critical mineral is selected from cobalt, gallium, germanium, hafnium, indium, lithium, magnesium, manganese, nickel, niobium, rubidium, tantalum, tellurium, and zinc.

Based on the highlighted aspects, here are relevant technical variations for the critical mineral extraction method:

Aspect 91. The method of any one of aspects 1-90, wherein the shale particulate composition is pre-treated by thermal activation at a temperature of about 200° C. to about 400° C. for about 1 hour to about 6 hours prior to mixing with water.

Aspect 92. The method of any one of aspects 1-91, wherein the shale particulate composition is pre-treated by microwave irradiation at a frequency of about 2.45 GHz for about 5 minutes to about 30 minutes to enhance mineral accessibility.

Aspect 93. The method of any one of aspects 1-92, wherein the water used to form the slurry is deionized water having a conductivity of less than about 10 μS/cm.

Aspect 94. The method of any one of aspects 1-93, wherein the water used to form the slurry is heated to a temperature of about 40° C. to about 80° C. prior to mixing with the shale particulate composition.

Aspect 95. The method of any one of aspects 1-94, wherein the filtering step is performed using vacuum filtration with a pressure differential of about 0.1 bar to about 0.8 bar.

Aspect 96. The method of any one of aspects 1-95, wherein the filtering step is performed using centrifugation at a speed of about 3000 rpm to about 8000 rpm for about 10 minutes to about 30 minutes.

Aspect 97. The method of any one of aspects 1-96, wherein the magnesium chloride solution further comprises a chelating agent selected from ethylenediaminetetraacetic acid (EDTA), citric acid, or oxalic acid at a concentration of about 0.01 M to about 0.1 M.

Aspect 98. The method of any one of aspects 1-97, wherein the magnesium chloride slurry is maintained at a temperature of about 25° C. to about 60° C. during mixing.

Aspect 99. The method of any one of aspects 1-98, wherein the first acid treatment is performed under ultrasonic agitation at a frequency of about 20 kHz to about 80 KHz.

Aspect 100. The method of any one of aspects 1-99, wherein the organic acid slurry is heated to a temperature of about 50° C. to about 90° C. during the first acid treatment.

Aspect 101. The method of any one of aspects 1-100, wherein the reducing agent solution further comprises a buffer system to maintain pH stability, wherein the buffer system comprises acetate buffer, phosphate buffer, or citrate buffer.

Aspect 102. The method of any one of aspects 1-101, wherein the reducing agent solution is purged with an inert gas selected from nitrogen, argon, or helium to maintain an oxygen-free environment.

Aspect 103. The method of any one of aspects 1-102, wherein the mineral acid treatment is performed under elevated pressure of about 1.5 bar to about 5 bar.

Aspect 104. The method of any one of aspects 1-103, wherein the mineral acid slurry is subjected to sonication during agitation to enhance mass transfer.

Aspect 105. The method of any one of aspects 1-104, wherein each leachate is analyzed for critical mineral content using inductively coupled plasma mass spectrometry (ICP-MS) or atomic absorption spectroscopy (AAS).

Aspect 106. The method of any one of aspects 1-105, wherein the final leachate undergoes a purification step comprising ion exchange, solvent extraction, or precipitation to concentrate the extracted critical mineral.

Aspect 107. The method of any one of aspects 1-106, wherein the stripped solid is subjected to a final washing step with dilute hydrochloric acid to recover any remaining critical minerals.

Aspect 108. The method of any one of aspects 1-107, wherein the method further comprises recycling at least one of the treatment solutions after critical mineral recovery.

Aspect 109. The method of any one of aspects 1-108, wherein the shale particulate composition is classified by particle size distribution prior to treatment, and different size fractions are processed separately.

Aspect 110. The method of any one of aspects 1-109, wherein the method is performed in a continuous flow reactor system rather than batch processing.

Aspect 111. The method of any one of aspects 1-110, wherein the critical mineral comprises multiple critical minerals selected from the group consisting of lithium, cobalt, nickel, manganese, and rare earth elements.

Aspect 112. The method of any one of aspects 1-111, wherein the extraction efficiency is enhanced by adding a surfactant selected from sodium dodecyl sulfate, Triton X-100, or cetyltrimethylammonium bromide at a concentration of about 0.01% to about 1% by weight.

Aspect 113. The method of any one of aspects 1-112, wherein the method includes real-time monitoring of extraction progress using pH measurement, conductivity measurement, or spectroscopic analysis.

Aspect 114. The method of any one of aspects 1-113, wherein the treatment conditions are optimized based on the specific mineralogical composition of the shale particulate composition as determined by X-ray diffraction analysis.

Aspect 115. The method of any one of aspects 1-114, wherein the method further comprises a pre-screening step to remove carbonate-rich fractions that may interfere with critical mineral extraction.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### F. REFERENCES

References are cited herein throughout using the format of last name of first author and publication year enclosed by parentheses corresponding to one or more of the following numbered references. For example, citation of references numbers 1 and 2 immediately herein below would be indicated in the disclosure as (Adeel et al., 2023 and Balaish et al., 2021).
1. Adeel, M., Zain, M., Shakoor, N., Ahmad, M. A., Azeem, I., Aziz, M. A., Tulcan, R. X., Rathore, A., Tahir, M., Horton, R., Xu, M., & Yukui, R. (2023). Global navigation of Lithium in water bodies and emerging human health crisis. Npj Clean Water, 6(1), 1-9. https://doi.org/10.1038/s41545-023-00238-w
2. Balaish, Moran, Juan Carlos Gonzalez-Rosillo, Kun Joong Kim, Yuntong Zhu, Zachary D. Hood, and Jennifer L M Rupp. “Processing thin but robust electrolytes for solid-state batteries.” Nature Energy 6, no. 3 (2021): 227-239.
3. Barghamadi, Marzieh, Ajay Kapoor, and Cuie Wen. “A review on Li—S batteries as a high efficiency rechargeable lithium battery.” Journal of the Electrochemical Society 160, no. 8 (2013): A1256.
4. Benson, Thomas R., Matthew A. Coble, and John H. Dilles. “Hydrothermal enrichment of lithium in intracaldera illite-bearing claystones.” Science Advances 9, no. 35 (2023): eadh8183.
5. Bhattacharya, Shailee, Shikha Sharma, Vikas Agrawal, Michael C. Dix, Giovanni Zanoni, Justin E. Birdwell, Albert S. Wylie Jr, and Tom Wagner. “Influence of Organic Matter Thermal Maturity on Rare Earth Element Distribution: A Study of Middle Devonian Black Shales from the Appalachian Basin, USA.” Energies 17, no. 9 (2024): 2107.
6. Bolan, Nanthi, Son A. Hoang, Mohsin Tanveer, Lei Wang, Shiv Bolan, Prasanthi Sooriyakumar, Brett Robinson et al. “From mine to mind and mobiles-Lithium contamination and its risk management.” Environmental Pollution 290 (2021): 118067.
7. Bowell, Robert J., Laura Lagos, Camilo R. de los Hoyos, and Julien Declercq. “Classification and characteristics of natural lithium resources.” Elements 16, no. 4 (2020): 259-264.
8. Canosa, F., Martin-Izard, A., Fuertes-Fuente, M., 2012. Evolved granitic systems as a source of rare-element deposits: the Ponte Segade case (Galicia, NW Spain). Lithos 153, 165-176.
9. Castor, S. B., Henry, C. D., 2020. Lithium-Rich Claystone in the McDermitt Caldera, Nevada, USA: Geologic, Mineralogical, and Geochemical Characteristics and possible Origin. Minerals 10, 68.
10. Cavalazzi, Barbara, Andrea Agangi, Roberto Barbieri, F. Franchi, and Giorgio Gasparotto. The formation of low-temperature sedimentary pyrite and its relationship with biologically-induced processes.” Geology of Ore Deposits 56 (2014): 395-408.
11. Chen, Ruiqian, and Shikha Sharma. “Role of alternating redox conditions in the formation of organic-rich interval in the Middle Devonian Marcellus Shale, Appalachian Basin, USA.” Palaeogeography, Palaeoclimatology, Palaeoecology 446 (2016): 85-97.
12. Chicharro, E., Boiron, M. C., Lopez-Garcia, J. A., Barfod, D. N., Villaseca, C., 2016. Origin, ore forming fluid evolution and timing of the Logros'an Sn—(W) ore deposits (Central Iberian Zone, Spain). Ore Geol. Rev. 72, 896-913.
13. Choi, Christopher, David S. Ashby, Danielle M. Butts, Ryan H. DeBlock, Qiulong Wei, Jonathan Lau, and Bruce Dunn. “Achieving high energy density and high power density with pseudocapacitive materials.” Nature Reviews Materials 5, no. 1 (2020): 5-19.
14. Chu, Hyunwon, Hyungjun Noh, Yun-Jung Kim, Seongmin Yuk, Ju-Hyuk Lee, Jinhong Lee, Hobeom Kwack, YunKyoung Kim, Doo-Kyung Yang, and Hee-Tak Kim. “Achieving three-dimensional lithium sulfide growth in lithium-sulfur batteries using high-donor-number anions.” Nature communications 10, no. 1 (2019): 188.
15. Clauer, N., Fallick, A. E., Eberl, D. D., Honty, M., Huff, W. D., Aubert, A., 2013. K—Ar dating and δ18O-δD characterization of nanometric illite from Ordovician K-bentonites of the Appalachians: illitization and the Acadian-Alleghenian tectonic activity. Am. Mineral. 98 (11-12), 2144-2154
16. Delle Piane, Claudio, Julien Bourdet, Matthew Josh, M. Ben Clennell, William D A Rickard, Martin Saunders, Neil Sherwood, Zhongsheng Li, David N. Dewhurst, and Mark D. Raven. “Organic matter network in post-mature Marcellus Shale: Effects on petrophysical properties.” AAPG Bulletin 102, no. 11 (2018): 2305-2332.
17. Deller Piane, C.; Bourdet, J.; Josh, M.; Clennell, M. B.; Rickard, W. D. A.; Saunders, M.; Sherwood, N.; Le, Z.; Dewhurst, D. N.; Raven, M. D. Organic matter network in post-mature Marcellus Shale: Effects on petrophysical properties. AAPG Bull. 2018, 102, 2305-2332. [CrossRef]
18. Dugamin E J, Richard A, Cathelineau M, Boiron M-C, Despinois F, Brisset A. Groundwater in sedimentary basins as potential lithium resource: A global prospective study. Sci Rep 2021; 11(1):21091.
19. Dugamin, Elza J M, Michel Cathelineau, Marie-Christine Boiron, Antonin Richard, and Frank Despinois. “Lithium enrichment processes in sedimentary formation waters.” Chemical Geology 635 (2023): 121626.
20. Silva, David, Lee Groat, Tânia Martins, and Robert Linnen. “Structural controls on the origin and emplacement of lithium-bearing pegmatites.” Can. J. Mineral. Petrol 61 (2023): 2300045.
21. E Peled, D Golodnitsky, E Strauss, Y Lavi Electrochim. Acta, 43 (1998), p. 1593
22. E Peled, D Golodnitsky, G Ardel, J Lang, Y Lavi J. Power Sources, 54 (1995), p. 496
23. E Strauss, D Golodnitsky, E Peled Electrochem. Solid State Lett., 3 (1999), p. 115
24. E. Peled, D. Golodnitsky, E. Strauss, J. Lang, Y. Lavi Electrochim. Acta, 43 (1998), p.
25. E. Peled, D. Golodnitsky, G. Ardel, J. Lang, Y. Lavi J. Power Sources, 54 (1995), p.
26. Ellis, Ben S., Dawid Szymanowski, Tomáš Magna, Julia Neukampf, Ralf Dohmen, Olivier Bachmann, Peter Ulmer, and Marcel Guillong. “Post-eruptive mobility of lithium in volcanic rocks.” Nature communications 9, no. 1 (2018): 3228.
27. Furukawa, Yoko, and H. L. Barnes. “Reactions forming pyrite from precipitated amorphous ferrous sulfide.” 1995.
28. Harper, John A. “The Marcellus shale—An old “new” gas reservoir in Pennsylvania.” Pennsylvania Geology 38, no. 1 (2008): 2-13.
29. Jørgensen, B. B. “Bacterial sulfate reduction within reduced microniches of oxidized marine sediments.” Marine Biology 41 (1977): 7-17.
30. Karrech, A., M. R. Azadi, M. Elchalakani, M. A. Shahin, and A. C. Seibi. “A review on methods for liberating lithium from pegmatities.” Minerals Engineering 145 (2020): 106085.
31. Kharaka, Y., Mariner, R., 1989. Chemical geothermometers and their application to formation waters from sedimentary basins. In: Naeser, N., McCulloh, T. (Eds.), Thermal History of Sedimentary Basins. Springer, New York, pp. 99-117
32. Kim, Jung Tae, Adwitiya Rao, Heng-Yong Nie, Yang Hu, Weihan Li, Feipeng Zhao, Sixu Deng et al. “Manipulating Li2S2/Li2S mixed discharge products of all-solid-state lithium-sulfur batteries for improved cycle life.” Nature Communications 14, no. 1 (2023): 6404.
33. Land, L., Macpherson, G., 1992. Geothermometry from brine analyses: lessons from the Gulf Coast, USA. Appl. Geochem. 7 (4), 333-340
34. Lash, Gary G., and David R. Blood. “Organic matter accumulation, redox, and diagenetic history of the Marcellus Formation, southwestern Pennsylvania, Appalachian basin.” Marine and Petroleum Geology 57 (2014): 244-263. Harvard
35. Laughrey, C. D., 2015, Using advanced geochemical techniques to determine the “line of death” productive limits of the Marcellus in N E Pennsylvania: AAPG Geoscience Technology Workshop Marcellus and Utica Point Pleasant, Pittsburgh, Pennsylvania, Jun. 17-19, 2014, accessed Aug. 21, 2017.
36. Laughrey, C. D., T. E. Ruble, H. Lemmens, J. Kostelnik, A. R. Butcher, G. Walker, and W. Knowles. “AV black shale diagenesis—insights from integrated high-definition analyses of post-mature Marcellus formation rocks, Northeastern Pennsylvania.” Is this reference complete (2011).
37. Laughrey, C. D., T. E. Ruble, H. Lemmens, J. Kostelnik, A. R. Butcher, G. Walker, and W. Knowles, 2011, Black shale diagenesis: Insights from integrated high-definition analyses of post-mature Marcellus Formation rocks, northeastern Pennsylvania: AAPG Search and Discovery article 110150, accessed Apr. 21, 2015.
38. Laughrey, Christopher D. “Produced Gas and Condensate Geochemistry of the Marcellus Formation in the Appalachian Basin: Insights into Petroleum Maturity, Migration, and Alteration in an Unconventional Shale Reservoir.” Minerals 12, no. 10 (2022): 1222.
39. Laughrey, Christopher D. “Produced Gas and Condensate Geochemistry of the Marcellus Formation in the Appalachian Basin: Insights into Petroleum Maturity, Migration, and Alteration in an Unconventional Shale Reservoir.” Minerals 12, no. 10 (2022): 1222.
40. Lee, Byong-June, Chen Zhao, Jeong-Hoon Yu, Tong-Hyun Kang, Hyean-Yeol Park, Joonhee Kang, Yongju Jung et al. “Development of high-energy non-aqueous lithium-sulfur batteries via redox-active interlayer strategy.” Nature Communications 13, no. 1 (2022): 4629.
41. Lengeler J W, Drews G, Schlegel H G. 1999. Biology of the Prokaryotes. Stuttgart: Georg Thieme. 955 p
42. Li, Wenshuai, Xiao-Ming Liu, and Oliver A. Chadwick. “Lithium isotope behavior in Hawaiian regoliths: Soil-atmosphere-biosphere exchanges.” Geochimica et Cosmochimica Acta 285 (2020): 175-192.
43. Li, Xin, Shi-Han Qi, Wen-Chao Zhang, Yue-Zhan Feng, and Jian-Min Ma. “Recent progress on FeS 2 as anodes for metal-ion batteries.” Rare Metals 39 (2020): 1239-1255.
44. Lim, Won-Gwang, Seoa Kim, Changshin Jo, and Jinwoo Lee. “A comprehensive review of materials with catalytic effects in Li—S batteries: enhanced redox kinetics.” Angewandte Chemie International Edition 58, no. 52 (2019): 18746-18757.
45. Liu, X. M., Rudnick, R. L., Hier-Majumder, S., Sirbescu, M. L. C., 2010. Processes controlling lithium isotopic distribution in contact aureoles: a case study of the Florence County pegmatites, Wisconsin. Geochem. Geophys. Geosyst. 11-18.
46. Macpherson, G. L. “Lithium in fluids from Paleozoic-aged reservoirs, Appalachian Plateau region, USA.” Applied Geochemistry 60 (2015): 72-77.
47. Macpherson, G. L., Capo, R. C., Stewart, B. W., Phan, T. T., Schroeder, K., Hammack, R. W., 2014. Temperature-dependent Li isotope ratios in Appalachian Plateau and Gulf Coast Sedimentary Basin saline water. Geofluids 14, 419-429
48. Maneta, V., Baker, D. R., 2019. The potential of lithium in alkali feldspars, quartz, and muscovite as a geochemical indicator in the exploration for lithium-rich granitic pegmatites: a case study from the spodumene-rich Moblan pegmatite, Quebec, Canada. J. Geochem. Explor. 205, 106336.
49. Monnier, L., Salvi, S., Melleton, J., Lach, P., Pochon, A., Bailly, L., Beziat, D., De Parseval, P., 2022. Mica trace-element signatures: Highlighting superimposed W—Sn mineralisations and fluid sources. Chem. Geol. 600, 120866.
50. Montoro, L. A., José Maurício Rosolen, J. H. Shin, and S. Passerini. “Investigations of natural pyrite in solvent-free polymer electrolyte, lithium metal batteries.” Electrochimica acta 49, no. 20 (2004): 3419-3427.
51. Peled, E., D. Golodnitsky, G. Ardel, J. Lang, and Y. Lavi. “Development and characterization of bipolar lithium composite polymer electrolyte (CPE)-FeS2 battery for applications in electric vehicles.” Journal of power sources 54, no. 2 (1995): 496-500.
52. Phan, Thai T., Rosemary C. Capo, Brian W. Stewart, G. L. Macpherson, Elisabeth L. Rowan, and Richard W. Hammack. “Factors controlling Li concentration and isotopic composition in formation waters and host rocks of Marcellus Shale, Appalachian Basin.” Chemical Geology 420 (2016): 162-179.
53. R Fong, J. R Dahn, C. H. W Jones J. Electrochem. Soc., 136 (1989), p. 3206
54. Sakuda, Atsushi, Tomonari Takeuchi, Kazuhiro Okamura, Hironori Kobayashi, Hikari Sakaebe, Kuniaki Tatsumi, and Zempachi Ogumi. “Rock-salt-type lithium metal sulphides as novel positive-electrode materials.” Scientific reports 4, no. 1 (2014): 4883.
55. Schoonen, Martin A A. “Mechanisms of sedimentary pyrite formation.” Special papers-Geological Society of America (2004): 117-134.
56. Silva, David, Lee Groat, Tânia Martins, and R. O. B. E. R. T. Linnen. “Structural controls on the origin and emplacement of lithium-bearing pegmatites.” Can. J. Mineral. Petrol 61 (2023): 2300045.
57. Soeder, Daniel J., and William M. Kappel. Water resources and natural gas production from the Marcellus Shale. Reston, VA: U S Department of the Interior, U S Geological Survey, 2009.
58. Sokolova, E. N., Smirnov, S. Z., Astrelina, E. I., Annikova, I. Y., 2011. Ongonite-elvan magmas of the Kalguty ore-magmatic system (Gorny Altai): composition, fluid regime, and genesis. Russ. Geol. Geophys. 52, 1378-1400.
59. Strauss, E., D. Golodnitsky, and E. Peled. “Study of phase changes during 500 full cycles of Li/composite polymer electrolyte/FeS2 battery.” Electrochimica acta 45, no. 8-9 (2000): 1519-1525.
60. Strauss, E., G. Ardel, V. Livshits, L. Burstein, D. Golodnitsky, and E. Peled. “Lithium polymer electrolyte pyrite rechargeable battery: comparative characterization of natural pyrite from different sources as cathode material.” Journal of power sources 88, no. 2 (2000): 206-218.
61. Susarla, Naresh, and Shabbir Ahmed. “Estimating Cost and Energy Demand in Producing Lithium Hexafluorophosphate for Li-Ion Battery Electrolyte.” Industrial & Engineering Chemistry Research 58, no. 9 (2019): 3754-3766.
62. Tao, Xinyong, Jianguo Wang, Chong Liu, Haotian Wang, Hongbin Yao, Guangyuan Zheng, Zhi Wei Seh et al. “Balancing surface adsorption and diffusion of lithium-polysulfides on nonconductive oxides for lithium-sulfur battery design.” Nature communications 7, no. 1 (2016): 11203.
63. Teng, F. Z., McDonough, W. F., Rudnick, R. L., Walker, R. J., Sirbescu, M. L. C., 2006. Lithium isotopic systematics of granites and pegmatites from the Black Hills, South Dakota. Am. Mineral. 91, 1488-1498.
64. Teng, F-Z., W. F. McDonough, R. L. Rudnick, C. Dalpé, P. B. Tomascak, B. W. Chappell, and S. Gao. “Lithium isotopic composition and concentration of the upper continental crust.” Geochimica et Cosmochimica Acta 68, no. 20 (2004): 4167-4178.
65. Trudinger, P. A. (1992). Bacterial sulfate reduction: current status and possible origin. In Early Organic Evolution: Implications for Mineral and Energy Resources (pp. 367-377). Berlin, Heidelberg: Springer Berlin Heidelberg.
66. Wang, Zeyi, Jiale Xia, Xiao Ji, Yijie Liu, Jiaxun Zhang, Xinzi He, Weiran Zhang, Hongli Wan, and Chunsheng Wang. “Lithium anode interlayer design for all-solid-state lithium-metal batteries.” Nature Energy (2024): 1-12.
67. Wilkin, R. T., and H. L. Barnes. “Formation processes of framboidal pyrite.” Geochimica et Cosmochimica Acta 61, no. 2 (1997): 323-339.
68. Worden, R. H., Griffiths, J., Wooldridge, L. J., Utley, J. E. P., Lawan, A. Y., Muhammed, D. D., Simon, N., Armitage, P. J., 2020. Chlorite in sandstones. Earth Sci. Rev. 204, 10310.
69. Wu, M., Samson, I. M., Zhang, D., 2017. Textural and chemical constraints on the formation of disseminated granite-hosted W—Ta—Nb mineralisation at the Dajishan Deposit, Nanling Range, Southeastern China. Econ. Geol. 112, 855-887.
70. Y Shao-Horn, S Osmialowski, Q. C Horn J. Electrochem. Soc., 149 (2002), p. A1547
71. Zhao, Haonan, Kunyue Ling, Shunqiao Qin, Meirong Lei, and Hanjie Wen. “Modes of occurrence of lithium in black shale in the Nandan area, Guangxi, S W China: implications for clay-type resources.” Ore Geology Reviews (2023): 105409.
72. Zhou, Guangmin, Hao Chen, and Yi Cui. “Formulating energy density for designing practical lithium-sulfur batteries.” Nature Energy 7, no. 4 (2022): 312-319.
73. Milliken, Kitty L., Mark Rudnicki, David N. Awwiller, and Tongwei Zhang. “Organic matter-hosted pore system, Marcellus formation (Devonian), Pennsylvania.” AAPG bulletin 97, no. 2 (2013): 177-200.
74. Kohl, Daniel, Rudy Slingerland, Mike Arthur, Reed Bracht, and Terry Engelder. “Sequence stratigraphy and depositional environments of the Shamokin (Union Springs) Member, Marcellus Formation, and associated strata in the middle Appalachian Basin.” AAPG bulletin 98, no. 3 (2014): 483-513.
75. Wiegand, B. A., O. A. Chadwick, P. M. Vitousek, and J. L. Wooden. “Ca cycling and isotopic fluxes in forested ecosystems in Hawaii.” Geophysical Research Letters 32, no. 11 (2005).
76. White, Art F., Marjorie S. Schulz, David A. Stonestrom, Davison V. Vivit, John Fitzpatrick, Tom D. Bullen, Kate Maher, and Alex E. Blum. “Chemical weathering of a marine terrace chronosequence, Santa Cruz, California. Part II: Solute profiles, gradients and the comparisons of contemporary and long-term weathering rates.” Geochimica et Cosmochimica Acta 73, no. 10 (2009): 2769-2803.
77. Bullen, Thomas, and Oliver Chadwick. “Ca, Sr and Ba stable isotopes reveal the fate of soil nutrients along a tropical climosequence in Hawaii.” Chemical Geology 422 (2016): 25-45.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### G. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Lithium Enrichment in Pyrite of Organic-Rich Black Shales

Within this Example, a suite of sedimentary samples are presented along with experimental observiations from the Appalachian basin to demonstrate the potential of Li recovery from the oxidizing fractions of shale, such as pyrite, and suggest a potential source of Li in brines from organic-rich shales. Herein it is demonstrated that pyrite can host a significant fraction of Li in shales that are not only organic-rich, but also have undergone low-grade metamorphism 280° C.

The Appalachian Basin (FIG. 1), an extensive geologic series of Middle Devonian rocks, spans eastern North America (He et al., 2019; Brett et al., 2011; Ver Straeten et al., 2011a, 2011b; Stein et al., 2007; Ettensohn et al., 1988; Woodrow et al., 1988). These rocks were deposited in an asymmetric foreland basin during the Acadian orogeny (Ettensohn and Barron, 1981). This Example focuses on specific stratigraphic units within this sequence, linking the fine-grained Marcellus subgroup from the basin's distal western margin to its proximal eastern margin. The Marcellus Formation illustrates a transition from basinal black shale to nearshore sandstone and alluvial deposits, reflecting a general shallowing upward trend (Ver Straeten et al., 1994; Ver Straeten and Brett, 2006; Ver Straeten, 2007). The Purcell Member is characterized by fine-grained bedded and nodular limestone (Ver Straeten et al., 1994; Ver Straeten and Brett, 2006). The Union Springs Formation, located between the upper and lower Marcellus subgroups, is thinner than the black shales but shows a less significant radioactive response and greater bulk density due to lower organic matter content and higher framework silicate content (Engelder et al., 2009). The stratigraphic sequence in this Example area is highly mature and electrically conductive (Laughrey et al., 2011; Laughrey, 2015; Piane et al., 2018). Thermal maturity indices indicate that both organic-lean and poor samples have experienced paleotemperatures around 280° C., displaying early signs of graphitization (Piane et al., 2018; Laughrey, 2022). Photomicrographs and SEM analyses suggest that these burial temperatures led to the formation of prehnite-pumpellyite facies in the deeper sections of the overmatured Appalachian Basin (Laughrey, 2022).

Sample Selection. The 15 samples were collected from two cored wells from the dry gas producing region of the Appalachian Basin. Preliminary elemental concentrations, TOC, and major oxides were measured, as outlined in Bhattacharya et al., 2024. XRD was used to perform the mineralogical characterization of the samples. All of the data used in this Example relates to the same intervals and depths. Ten core samples-A1 through C3 (plugs and segments) from the Marcellus formation, as well as samples from strata above and below it, and five cuttings-D1 through E3, are included herein (Table 1). The raw samples were submitted for successive leaching tests after being homogenized to 75 microns.

Sequential Leaching. The leaching procedure and analytical techniques are described in Bhattacharya et al., 2024. The method can be briefly outlined as follows. 10 g of a sample (75 microns) was rinsed with DI water and rolled in centrifuge vials on an orbital shaker for 18 hours on an orbital shaker. A 0.45 μm Millipore membrane filter was used to filter the fluid. Following that, chemicals were applied to extract the shale's inorganic and organic components successively. To begin, the exchangeable fraction was dissolved in magnesium chloride. Second, acetic acid was used to target carbonates and phosphates. The Fe—Mn oxyhydroxides were subsequently dissolved for 6 hours at pH 2 in hydroxylamine hydrochloride in 25% acetic acid. Next, pyrite was dissolved in nitric acid by constant shaking for 18 h at room temperature. The final step was to dissolve organically associated particles. This was carried out by combusting the residue after pyrite dissolution in a furnace at 650° C. in porcelain crucibles for 3h to oxidize the organics. After combustion, the sample was washed with diluted HCl and shaken for 4 h. The supernatant fluids formed after every leaching step were collected by vacuum filtering using 0.45 um membrane filters and subsequently acidified with 1% concentrated nitric acid to prevent chemical deterioration of the sample. Additionally, the sample residue after each leaching step was washed in 150 ml of deionized water, collected, and acidified for future analyses (if necessary) to account for the elemental loss in between the leaching steps.

Elemental Analysis. Following the quality assurance/quality control process, these steps were followed to assure analytical accuracy and repeatability. The instrument was tested daily with four points and a blank, as well as a positive and negative check. The affirmative check was to assure adequate recovery. The negative check (or continuous blank) ensured that the blank was less than the method detection limit. Check standards were run every 10 injections to confirm that the analytical uncertainty for the calibration verification standard was within +/−10% and calibration blank standards were run every 10 samples. In addition to one sample run in triplicate, each batch of 20 samples included a blank and a laboratory control spike.

Distribution of Li in Bulk Rock. The mineralogical and major element data presented in the subsequent figures in this study are published in Bhattacharya et al., 2024. There are three distinct mineralogical patterns (FIG. 2) with considerable overlaps— i) high clay/low TOC-pyrite-carbonate (HCY), ii) medium clay/high pyrite-TOC/low carbonate (HPT), and iii) medium clay/high TOC/high carbonate (HTC). HC samples are D1, D2, D3, E1, and E2, and HPT samples are A2 and D1, and HPC samples are A1, A2, C2, and C3. Note that samples with a high carbonate content usually have a lower pyrite content. All the clays are in the form of illite. Smectite is undetected in the mixed clay layers, which suggests this stratigraphic section has undergone thermal alteration (Worden et al., 2020), leading to complete illitization of the smectite. As has been described in several recent studies (Phan et al., 2016; Zhao et al., 2023; Benson et al., 2023), illitization is an important process by which a significant fraction of Li gets mobilized, caused by smectite dewatering, and then incorporated into authigenic minerals. There is negligible change in the quartz-plagioclase abundance, suggesting that these framework silicates have neither been affected by the burial diagenesis nor been altered by low-grade metamorphism. The HTC layers show some degree of variation in the carbonate minerals, in the form of calcite, dolomite, and Fe-dolomite. These minerals may have negligible to moderate influence on the Li distribution as discussed below.

Samples with high illite and siliciclastic contents, namely, D1, D2, D3, E1, E2, and E3 (FIG. 2), correspond to the highest Li contents in the bulk rock (FIG. 4), which is expected as those are also the samples posing the least effect of carbonate, OM, and pyrite dilution. Moreover, the highest illite-containing samples suggest that the samples were originally high in smectite and that the clays were already enriched in Li, which is also observed in the magnesian smectites in the McDermitt caldera (Benson et al., 2023). Conversely, carbonate-induced (A1, C1, C2) and OM-pyrite-induced (A2, B, C3) dilution of silicate weathering input is observed in D1 and E (FIG. 2). FIG. 3 demonstrates a correlation between illite content and whole rock Li content.

To remove the effect of clay dilution from the high TOC-pyrite-carbonate samples and evaluate the degree of enrichment with respect to clay, Li was normalized to illite, Rb, Ga, and oxides of K, Si, Al, and Ti (FIGS. 4B-4H). Although the variability of Li content is significant across the 15 samples, there is little to no difference in its association with clay phases in all samples, and it consistently exhibits a moderate to strong positive correlation (r²=0.75-0.92). However, the 3 bottom-most samples, A1 and A2, show a negative trend, thereby demonstrating that the non-clay phases strongly influence a different Li chemistry in those beds. This observation suggests that although the silicate fraction is still the most dominant mineral phase in these shales except for A1, the dilution effect on Li plays a key role in Li content and its association with pyrite, OM, and carbonates. To investigate this, a traditional sequential leaching of the major shale-forming minerals was performed.

Li Association with Pyrite. The total recoverable Li from each extracted phase of the samples is presented in Table 1 and FIG. 5. The target phases were acid-soluble (carbonates), Fe—Mn (oxy) hydroxides, pyrite, and organics. Silicates were not digested as it is an energy-heavy step. Exchangeable phases were extracted prior to the acid-soluble, but not analyzed as these samples were devoid of any traces of porewaters, suggesting that Li would likely not be found in high concentrations within the exchangeable phases. The highest fractions of Li across all samples were recovered from the pyrite phases and the least from the Fe—Mn oxides. No studies have reported an association of Li with pyrite. To validate this observation further, an analysis was done of Li recovery from the Haynesville shale (1Ha, 5Hb) and Marcellus shale samples (MIP-3H) used in the Bhattacharya et al., 2022 study. Although the leaching technique was different than this experiment's, similar observations were made in the leachability of Li from pyrite, suggesting strong mineralogical influence on Li recovery (FIG. 7). The Haynesville samples are relatively carbonate-rich, organic-poor and the mature organic-rich MIP-3H contains 11% pyrite by weight. The comparative analysis of two basins demonstrates that the samples are not only mineralogically distinctive, but also represent two time periods, further asserting the idea that pyrite likely associates with Li under similar geochemical conditions.

TABLE 1

| | | | | | Fe—Mn |
|---|---|---|---|---|---|
| | Whole | Pyrite | Organic | Acid-soluble | oxide |
| | rock | content | leachate | leachate | leachate |
| Sample ID | Li mg/kg | wt % | mg/L | mg/L | mg/L |
| E3 | 71 | 0.3 | 0.457 | 0.524 | 0.153 |
| E2 | 71 | 0.3 | 0.56 | 0.651 | 0.146 |
| E1 | 79 | 0.4 | 0.523 | 0.578 | 0.241 |
| D3 | 103 | 2 | 0.77 | 0.521 | 0.149 |
| D2 | 95 | 1.1 | 0.892 | 0.884 | 0.215 |
| D1-I | 91 | 2.5 | 0.679 | 0.65 | 0.177 |
| D1-II | 57 | 6.1 | 0.235 | 0.804 | 0.204 |
| C3 | 34 | 1.9 | 0.1 | 1.332 | 0.301 |
| C2 | 25 | 1.4 | 0.057 | 1.024 | 0.377 |
| C1 | 22 | 2.5 | 0.119 | 3.809 | 1.664 |
| B-I | 29 | 4.8 | 0.106 | 1.779 | 0.164 |
| B-II | 22 | 7.1 | 0.089 | 0.254 | 0.185 |
| A2-I | 22 | 5.2 | 0.05 | 0.123 | 0.163 |
| A2-II | 22 | 5.9 | 0.086 | 0.158 | 0.178 |
| A1 | 24 | 2.1 | 0.078 | 0.235 | 0.048 |

| | Pyrite | Total | Li |
|---|---|---|---|
| Sample | leachate | extracted Li | recovered |
| ID | mg/L | mg/L | % |
| E3 | 3.424 | 4.558 | 6.42 |
| E2 | 3.171 | 4.528 | 6.38 |
| E1 | 4.39 | 5.732 | 7.26 |
| D3 | 6.108 | 7.548 | 7.33 |
| D2 | 3.121 | 5.112 | 5.38 |
| D1-I | 5.449 | 6.955 | 7.64 |
| D1-II | 10.511 | 11.754 | 20.62 |
| C3 | 3.134 | 4.867 | 14.31 |
| C2 | 2.01 | 3.468 | 13.87 |
| C1 | 4.509 | 10.101 | 45.91 |
| B-I | 6.209 | 8.258 | 28.48 |
| B-II | 11.207 | 11.735 | 53.34 |
| A2-I | 8.047 | 8.383 | 38.10 |
| A2-II | 11.168 | 11.59 | 52.68 |
| A1 | 2.7 | 3.061 | 12.75 |

In many studies, pyrite, along with other sulfides and OM, is generally referred to as the oxidizable fraction in black shales. Most have considered Li association with elemental S and Fe, but there has not been any indication of a direct association of Li with S (Zhao et al., 2023). It is true for these samples too, that is, there is no apparent correlation between bulk rock Li and S. However, syngenetic pyritization is a complex process, often involving OM and calcite (Cavalazzi et al., 2014), thereby complicating the Li-geochemistry in the non-silicate fractions. Furthermore, the Li footprint in these samples is not only a result of burial diagenesis but also considerable thermal maturation, making it more challenging to demarcate the role of the series of geological events in Li behavior and mode of enrichment. To that end, two possible mechanisms of enrichment are proposed that could allow pyrites to sequester Li. It is well known that pyrites are abundantly present as framboids in organic-rich shales in the Marcellus basin (Lash and Blood, 2014; Chen and Sharma, 2016), and yet its formation mechanism and geochemical association to organic matter is not well understood.

Before analyzing Li occurrence in Marcellus pyrites, it is first important to understand the occurrence and formation of pyrite under fluctuating anoxic conditions that are representative of the Northern Appalachian Basin (NAB). While several models have been proposed, it is established that greigite and, to an extent, mackinawite are important precursors to framboidal pyrite (Wilkin and Barnes, 1997; Schoonen, 2004). These iron monosulfides form because of bisulfide complexes reacting with ferrous ions such as FeHS⁺ (aq) and Fe(HS)₂⁰ (aq). Conversely, while the solutions are undersaturated with respect to mackinawite, the sulfidic waters are invariably supersaturated with respect to pyrite, and hence pyrite formation via the precipitation pathway is thermodynamically more favorable than direct nucleation (references in Wilkins and Barnes, 1997). Furthermore, the reaction rates are catalyzed in steep chemical gradients at the O₂—H₂S interface (Jorgensen, 1977). Organic material is often spatially associated with framboids (Lengeler et. al., 1999; Cavalazzi et al., 2014). Sulfate reduction is mediated by bacteria that oxidize H₂ from the outside environment to reduce SO via either microbial degradation of ligands such as pyruvate or lactate or by other complex processes that produce insufficient but necessary quantities of H₂ to sustain sulfate reduction reactions. At this stage when pyrite precipitation is about to begin, understanding the geochemical state of Li is critical. Lithium is a soluble element, but its concentration is highly variable in sedimentary rocks. The variability is often a function not only of the (a) host rock mineralogy, as was observed in bulk rocks herein, but also of the (b) source of weathered Li (based on isotopic measurements on porewaters) (Wiegand et al., 2005; White et al., 2009; Bullen and Chadwick, 2016), (c) diagenetic reactions with Li-bearing minerals in the shale (Macpherson et al., 2014), and the (d) fluid chemistry containing lithium (Bolan et al., 2021). Furthermore, there are also huge differences in the partitioning coefficients of Li ions depending on the source or processes the Li species has undergone. For instance, Lit, which originates from the weathering of lithium compounds, has a much lower K_{d} and therefore tends to remain in solution or does not complex easily with OM or sediment colloids. This species of Li, subsequently, is more bioavailable than geogenic Li with Kd as high as 500 (Bolan et al., 2021), originating from the weathering of volcanogenic silicates and clay minerals (Phan et al., 2016). As a result, the more incompatible Li is readily available for plant uptake, and isotopic evidence indicates that bio-available Li is isotopically lighter (Kalinowska et al., 2013; Shahzad et al., 2016; Robinson et al., 2018). The plant material recycles back Li into the sediments as litterfall, which subsequently accumulates as organic matter (Li et al., 2020). Bio-cycled Li is a potential component in this Example, especially in the organic-rich horizons. This is based on observations that Li is more readily recovered from the A2, B, and C1 horizons, although from the pyrite phase.

At the oxic-anoxic interface of circumneutral sulfidic waters, when greigite or mackinawite formation is initiated, sulfide generation is accelerated by bacterial activity and is deposited around organic particles present in the porewaters (Jorgensen, 1977; Trudinger et al., 1985). The following equations given below suggest a probable pathway for the formation of a pyrite precursor and its eventual transformation to pyrite (Wilkin and Barnes, 1997).

$${Fe}^{2 +} + {HS}^{-} {=}^{′} {FeS}^{′} ( greigite ) + {H}^{+} \qquad Eqn . 1$$

$${Fe}_{3} {S}_{4} + 2 {H}_{2} S ⇔ 3 {FeS}_{2} + 4 {H}^{+} + 4 {e}^{-} \qquad Eqn . 2$$

$$4 {H}^{+} + 4 {e}^{-} + 2 {S}^{0} ⇔ 2 {H}_{2} S \qquad Eqn . 3$$

$${Fe}_{3} {S}_{4} + 2 {S}^{0} ⇔ 3 {FeS}_{2} \qquad Eqn . 4$$

The replacement can also be expressed in terms of iron-loss (Furukawa and Barnes, 1995), i.e.,

$${Fe}_{3} {S}_{4} + 2 {H}^{+} = 2 {FeS}_{2} + {Fe}^{{2}^{+}} + {H}_{{2}_{g}} \qquad Eqn . 5$$

The sulfidic porewaters may likely be enriched in bio-cycled lithium and remain in the solution. A fraction of the dissolved Li complexes with bicarbonates and precipitates out if the solution is supersaturated with respect to Ca²⁺. It was observed that carbonate-rich horizons such as C3 and C1 have a relatively higher Li recovery from the acid-soluble phase (FIG. 7), suggesting significant dilution due to the presence of carbonates in these samples. However, when the carbonate dilution effect is insignificant, pyrite formation may induce the adsorption of a fraction of dissolved Li. This is plausible pathway because pyrites are closely associated with organic matter, and several studies have reported the incorporation of metals into pyrites in the presence of benthic organisms in the sediments (Schoonen et al., 2004 and references within). Li being a micronutrient for plants makes it likely that physical adsorption on syngenetic pyrite was significantly high, which explains the high leachability of Li. The data supports this mechanistic model, as seen that the fraction of Li extracted is directly proportional to the pyrite content (FIG. 8). This suggests that organics and pyrites are closely controlling the behavior of Li, and this nature of association is starkly different from the clay-dominated rocks in the upper horizons. Given that isotopic studies have already established the occurrence of a wide range of K_{d} values depending on its source, it is possible that the predominant source of Li, in this Example most likely bio-cycled Li, likely plays a role in making syngenetic pyrites behave as a trap for excess dissolved Li in the porewaters. This mechanism helps explain several key observations in this study.

Link to Burial Diagenesis Metamorphic Grade and High Thermal Maturity. Another interesting observation from the leaching experiment is presented in FIG. 9. The extracted Li (mg/L) and whole rock Li (mg/kg) are compared to whole rock pyrite (wt %). As the whole rock Li decreases in content from left to right (indicated by a decrease in the solid circle radius), the total extracted Li concentration increases. This trend is demonstrated by red arrows to show a drop in recovery in samples with a starting higher whole rock Li, and blue arrows to indicate an increase in recovery in samples with lower whole rock Li. This is counterintuitive because a higher degree of recovery is expected from a sample with a higher Li amount. However, this observation can be tenable if there are different sources of Li, being released from the samples obtained from different stratigraphic depths.

Phan et al., 2016 show from the Marcellus Basin formation water study, a wide range of Li isotopic signals were recorded in the formation waters sampled from north-central PA and south-western PA, which is another line of evidence to support the hypothesis that different Li sources are contributing to the formation water Li signal. Furthermore, to estimate reservoir temperatures attained during illitization, geothermometric calculations on the fluids were performed in that study. The results of the Mg/Li geothermometer (Kharaka and Mariner, 1989; Land and Macpherson, 1992) indicate that reservoirs in the eastern part of the Appalachian Basin reached paleotemperatures of 187±11° C. Macpherson et al., 2014 studied Li in fluids from the Paleozoic fluids in the Appalachian Plateau and concluded that anomalously high Li concentrations coincided with samples having high vitrinite reflectance. Other studies suggest the eastern part of the Appalachian Basin has mineral assemblages corresponding to the metamorphic prehnite-pumpellyite facies (300-400° C.) (Laughrey et al., 2011; Piane et al., 2018; Laughrey, 2022). The possible association of Li with pyrite has been extensively studied in electrochemical research as well (Strauss et al., 1999) which further corroborates our mechanistic understanding. At temperatures near 350° C., pyrite can react with the excess porewater Li caused by diagenetic reactions to precipitate amorphous Li₂FeS₂. It is also possible that traces of Li₂S dissolve in the porewater due to its high solubility and precipitate Fe₂S as shown by the following equations:

$${Fe}^{0} + 2 {Li}_{2} S - 2 {e}^{-} \to {Li}_{2} {FeS}_{2} + 2 {Li}^{+} \qquad Eqn . 6$$

$${Li}_{2} {FeS}_{2} - {xe}^{-} \to {Li}_{2 - x} {FeS}_{2} + {x Li}^{+} ( 0 < x < 0 \text{.8} ) \qquad Eqn . 7$$

$${Li}_{2 - x} {FeS}_{2} - ( 2 - x ) {e}^{-} \to {FeS}_{y} + ( 2 - y ) S + ( 2 - x ) {Li}^{+} \qquad Eqn . 8$$

At temperatures of 300-400° C., pyrite can react with dissolved Li (Peled et al., 1995; 1998; Strauss et al., 1999) because of the irreversibility of reaction steps induced by delithiation (Eqns. 6,7). As temperatures decrease, the hexagonal framework of Li₂FeS₂ decomposes to liberate FeSx and S when lithium is removed (Eqn. 8) (Fong et al., 1989). However, at temperatures above 400° C., the dissolved Li reacts with pyrite through a two-step process as shown in Eqn. 9 and Eqn. 10.

$${FeS}_{2} + 2 {Li}^{+} + 2 {e}^{-} \to {Li}_{2} {FeS}_{2} ( FeS + {Li}_{2} S ) \qquad Eqn . 9$$

$${Li}_{2} {FeS}_{2} ( FeS + {Li}_{2} S ) + 2 {Li}^{+} + 2 {e}^{-} \to Fe + 2 {Li}_{2} S \qquad Eqn . 10$$

Because of the property of full reversibility, lithium-pyrite batteries have demonstrated good performance (around 200 Wh/kg) at high temperatures (400-450° C.) (Horn et al. 2002). These reactions strongly suggest that Li-sulfide formation is a high-temperature dependent process and is likely to occur in overmatured, low-grade metamorphosed sedimentary basins.

Although the exact impact of every geologic process affecting the part of the basin where the samples were collected from is not well-established yet, it is accepted that there is a complex interplay of several events thus affecting the shale mineralogy, formation, and porewater chemistry, and rock-fluid interactions in the eastern Appalachian basin (Clauer et al., 2013; Phan et al., 2016).

Model Summary. The variability in lithium concentration depends on several factors: (a) the mineralogy of the host rock, as seen in the bulk rock samples; (b) the source of weathered lithium, determined through isotopic measurements of porewaters; (c) diagenetic reactions involving lithium-bearing minerals in the shale; and (d) the chemistry of the lithium-containing fluid. Lithium ions (Li⁺), originating from the weathering of lithium compounds, have a low distribution coefficient (Kd) and tend to remain in solution, making them more bioavailable. In contrast, geogenic lithium, with a Kd as high as 500, comes from the weathering of volcanogenic silicates and clay minerals and is less bioavailable. The more incompatible lithium is readily taken up by plants, and isotopic evidence shows that this bioavailable lithium is isotopically lighter. Plants recycle this lithium back into the soil as litterfall, accumulating as organic matter. Bio-cycled lithium is significant, especially in organic-rich horizons. Observations indicate that lithium is more readily recovered from the A2, B, and C1 horizons, particularly from the pyrite phase. This process highlights bio-cycled lithium's contribution to overall lithium enrichment in these horizons. The Example's findings emphasize the role of plant uptake and recycling in lithium dynamics within the soil. FIG. 10 demonstrates a schematic diagram for entrichment of pyrites with Li.

### 2. Exemplary Sequential Leaching Method

In an exemplary method of the present disclosure, a sequential leaching method was carried out using 10 g of an organic-rich black shale sample (75 μm particle size) that was first washed with 150 ml of deionized (DI) water in a 400 mL borosilicate beaker and rolled for 18 hours on an orbital shaker. The fluid was filtered using a 0.45 μm membrane filter REF #: HTTP04700, LOT #0000163628, Isopore™, Filter type PC membrane). Following this, reagents as further discussed below were added to sequentially extract the inorganic and organic fractions from the shale (see Bhattacharya et al., 2024). The volumes of the reagents were considered to match the fluid: rock ratio of 10:1 for this study. First, 80 mL of 1M magnesium chloride was used to dissolve the exchangeable fraction. Second, the carbonates and phosphates were extracted using 150 mL of 1N acetic acid, and constant shaking for 6 hours (h) at room temperature. Next, the Fe—Mn oxyhydroxides were dissolved using 150 mL of 0.05M hydroxylamine hydrochloride in 25% acetic acid for 6 h at pH 2. Following the oxyhydroxides, pyrite was dissolved in 150 ml of 2M nitric acid by constant shaking for 18 h at room temperature. The final step was designed to target the organically associated particles. First, the sample residue remaining after pyrite dissolution was combusted in a furnace at 650° C. in porcelain crucibles for 3 h to oxidize the organics. This step was performed to ensure the REE would be concentrated as rare earth oxides in the burnt residue that is predominantly a refractory material, i.e., silicates. After combustion, the sample was washed in 150 mL of 0.1M HCl and shaken for 4 h to separate the REE from the residue. The supernatant fluids formed after every leaching step were collected by vacuum filtering using 0.45 μm membrane filters and subsequently acidified with 1% conc. nitric acid to prevent chemical deterioration of the sample. Additionally, the sample residue after each leaching step was washed in 150 mL of DI water, collected, and acidified for future analyses (if necessary) to account for the elemental loss in between the leaching steps. A schematic view of the foregoing is shown in FIG. 10.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method, comprising:
providing a shale particulate composition comprising a total organic carbon content of at least 0.5 wt % and at least one critical mineral;
mixing the shale particulate composition with water, thereby forming a slurry;
filtering the slurry, thereby forming a shale particulate retentate and a first filtrate;
mixing the shale particulate retentate and a magnesium chloride solution, thereby forming a magnesium chloride slurry comprising a first solid and a first leachate;
mixing the first solid with a first acid, thereby forming an organic acid slurry comprising a second solid and a second leachate;
mixing the second solid with a reducing agent solution, thereby forming a reduced slurry comprising a third solid and a third leachate; and
mixing the third solid with a mineral acid, thereby forming a mineral acid slurry comprising a stripped solid and a final leachate;
wherein the final leachate comprises at least one extracted critical mineral.

2. The method of claim 1, wherein the slurry is agitated prior to filtering.

3. The method of claim 2, wherein the slurry is agitated for about 10 hours to about 30 hours.

4. The method of claim 1, wherein the magnesium chloride solution and the shale particulate retentate are mixed at a weight ratio of about 10:1 to about 6:1 (magnesium chloride solution:shale particulate retentate).

5. The method of claim 1, wherein the magnesium chloride solution has a concentration of magnesium chloride of about 0.5 M to about 2.0 M.

6. The method of claim 1, wherein the first acid and the first solid are mixed at a weight ratio of about 20:1 to about 10:1 (first acid:first solid).

7. The method of claim 1, wherein the first acid comprises hydrochloric acid, acetic acid, formic acid, citric acid, oxalic acid, or any combination thereof.

8. The method of claim 1, wherein the first acid has a concentration of about 0.5 M to about 2.0 M.

9. The method of claim 1, wherein the reducing agent solution and the second solid are mixed at a weight ratio of about 20:1 to about 10:1 (reducing agent solution:second solid).

10. The method of claim 1, wherein the reducing agent solution comprises a reducing agent and a second acid.

11. The method of claim 10, wherein the reducing agent is hydroxylamine hydrochloride, sodium sulfite, ascorbic acid, sodium ascorbate, or any combination thereof.

12. The method of claim 10, wherein the concentration of the reducing agent in the reducing agent solution ranges from about 0.01 M to about 0.10 M.

13. The method of claim 10, wherein the second acid comprises acetic acid, formic acid, citric acid, oxalic acid, or any combination thereof.

14. The method of claim 1, wherein the pH of the reduced slurry is about 1.0 to about 3.

15. The method of claim 1, wherein the mineral acid and the third solid are mixed at a weight ratio of about 20:1 to about 10:1 (mineral acid:third solid).

16. The method of claim 1, wherein mixing the third solid and the mineral acid further comprises agitating the third solid and the mineral acid.

17. The method of claim 16, wherein the third solid and the mineral acid are agitated for about 10 hours to about 30 hours.

18. The method of claim 1, wherein the mineral acid comprises nitric acid, hydrochloric acid, sulfuric acid, an oxidizing agent, a reducing agent, or any combination thereof.

19. The method of claim 1, wherein the critical mineral comprises lithium and the final leachate comprises at least about 20% of the lithium present in the shale particulate composition.

20. The method of claim 1, wherein the shale particulate composition comprises a total organic carbon content of at least about 5 wt % and a pyrite content of at least about 2.5 wt %.
